(19) United States
(12) Patent Application Publication
(10) Pub. No.: US 2025/0058301 A1
(43) Pub. Date: Feb. 20, 2025

(54) SYSTEMS AND METHODS FOR RAPID DESORPTION OF POLAR MOLECULE BEARING ADSORBENT MATERIAL USING RF ENERGY

(71) Applicant: STARFIRE ENERGY, Denver, CO (US)

(72) Inventors: Henrik F. BERNHEIM, Denver, CO (US); Joseph D. BEACH, Denver, CO (US); Jonathan D. KINTNER, Aurora, CO (US); Alex G. Bernacchi, JR., Denver, CO (US)

(21) Appl. No.: 18/728,806

(22) PCT Filed: Jan. 17, 2023
(86) PCT No.: PCT/US2023/060785

§ 371 Date: Jul. 12, 2024

Related U.S. Application Data
(60) Provisional application No. 63/299,785, filed on Jan. 14, 2022.

(51) Int. Cl. B01J 20/34; B01D 53/04; B01J 20/18

(52) U.S. Cl. CPC B01J 20/3441; B01D 53/0438; B01D 53/0454; B01J 20/18; B01J 20/3408; B01D 2253/108; B01D 2257/406; B01D 2259/40098

(57) ABSTRACT

Method and systems for rapidly desorbing a quantity of polar molecules from adsorbent material by exposing the adsorbent material to radio frequency energy are described.

### CROSS-REFERENCE TO RELATED APPLICATION(S)

This application claims priority to U.S. Provisional Patent Application No. 63/299,785, entitled SYSTEMS AND METHODS FOR RAPID DESORPTION OF POLAR MOLECULE BEARING ADSORBENT MATERIAL USING RF ENERGY, and filed on Jan. 14, 2022, the entire disclosure of which is incorporated herein by reference for all purposes.

### TECHNICAL FIELD

The technology described herein generally relates to systems and methods for removing adsorbed polar molecules from an adsorbent material by exposing the adsorbent material to radio frequency (RF) energy and recovering the released (desorbed) polar molecules. Polar molecules recovered in this manner can be used directly or stored for later use. One such type polar molecule of particular interest is gaseous anhydrous ammonia (NH₃), although other types of polar molecules are also useful and can be recovered by the technology described herein as well.

### BACKGROUND

Human-caused emissions of carbon dioxide (CO₂) are causing global warming, climate changes, and ocean acidification. These threaten humanity's continued health, life, economic development and security. To counter this threat, energy sources that are substantially free of CO₂ emissions are highly sought after in both industrialized and developing countries. While several CO₂-free energy generation options have been extensively developed, none presently include a practicable CO₂-free fuel.

Ammonia (NH₃) can be burned with oxygen (O₂) as a fuel yielding nitrogen (N₂) and water (H₂O) according to the following reaction equation (1):

$$4 {NH}_{3} + 3 {O}_{2} \to 2 {N}_{2} + 6 {H}_{2} O + heat \qquad ( 1 )$$

Ammonia (NH₃) can be used directly as a carbon-free fuel or as a hydrogen source if it is reformed into hydrogen and nitrogen gases. It can also be used in a mixture of NH₃, H₂, and N₂ to tailor its combustion characteristics to specific processes or equipment. It has a higher energy density, easier storage conditions, and cheaper long-term storage and distribution than gaseous hydrogen, liquid hydrogen, or batteries.

The main industrial process for the production of ammonia is the Haber-Bosch process, illustrated in the following reaction equation (2):

$${N}_{2} ( g ) + 3 {H}_{2} ( g ) \to 2 N {H}_{3} ( g ) ( Δ H = - 9 2.2 kJ / mol ) \qquad ( 2 )$$

In 2005, Haber-Bosch ammonia synthesis produced an average of about 2.1 tonnes of CO₂, per tonne of NH₃ produced. About two thirds of the CO₂ production derives from steam reforming with hydrocarbons to produce hydrogen gas, while the remaining third derives from hydrocarbon fuel combustion to provide energy to the synthesis plant. As of 2005, about 75% of Haber-Bosch NH₃ plants used natural gas as feed and fuel, while the remainder used coal or petroleum. Haber-Bosch NH₃ synthesis consumed about 3% to 5% of global natural gas production and about 1% to 2% of global energy production.

The Haber-Bosch reaction is generally carried out in a reactor containing an iron oxide or a ruthenium catalyst at a temperature of between about 300° C. and about 550° C., typically at a pressure of between about 90 bar and about 180 bar. There are some systems that operate at an upper pressure of about 300 bar. The elevated temperature is required to achieve a reasonable reaction rate. Due to the exothermic nature of NH₃ synthesis, the elevated temperature drives the equilibrium toward the reactants, but this is counteracted by the high pressure.

Recent advances in ammonia synthesis have yielded reactors that can operate at temperatures between about 300° C. and about 600° C. and pressures ranging from 1 bar up to the practical limits of pressure vessel and compressor design. When designed for lower operating pressures, this newer generation of reactors can reduce equipment costs and gas compression costs, but they also reduce the fraction of the N₂ and H₂ reactants converted to NH₃ during each pass through the catalyst bed. Rather than liquefying the NH₃ to remove it from the product stream, these reactors use an adsorbent material to achieve a gas phase NH₃ removal as described in U.S. Pat. No. 10,787,367, the entirety of which is hereby incorporated by reference.

The gas phase removal of polar molecules (including, but not limited to NH₃) from the reactor product stream is highly advantageous because it allows the reactor to be operated at a broad range of pressures, flows, and temperatures. Ideally, the polar molecules should be removed from the adsorbent material in pure form for subsequent liquefaction and storage. Otherwise, the impurities contained in the output flow must be removed through a secondary method. Traditional removal methods include Pressure Swing Adsorption (PSA) and Temperature Programmed Desorption (TPD). Pressure Swing Adsorption is limited by the pressure differential required to break the bonds between the adsorbent material and the adsorbed polar molecules and is therefore not practical for all types of polar molecules. Temperature Programmed Desorption is applicable for a wider range of polar molecules but suffers from the time required to elevate the temperature of the adsorbent material sufficiently to break the bonds between the adsorbent material and the adsorbed polar molecules, the maximum temperature to which the adsorbent material must be exposed, the time to return the adsorbent material to the adsorption temperature range and the degradation of the adsorbent material as a result of subjecting the adsorbent materials to repetitive temperature excursions from adsorption temperature to maximum required desorption temperature. Under the Temperature Programmed Desorption process, the adsorbent material will typically have a maximum rate of temperature increase, on the order of 1° C. to 3° C. per minute, which elongates time to reach desorption temperature. It is noted that some adsorbents can tolerate a significantly higher rate of temperature increase, on the order of approximately 10° C. per minute, but this is dependent on the combination of adsorbent, the composition of the process gas or gasses, the specific polar molecules adsorbed by the adsorbent, the temperature range of system operation and the range of the ambient temperature when the system is not operating.

Adsorbents typically have poor thermal transmission properties, requiring the use of a heated gas stream or multiple heaters, or a combination thereof, to achieve uniform heating of the adsorbent material. As a result, the vessels holding adsorbent material tend to be large, requiring a significant volume of adsorbent that must be periodically replaced due to temperature related degradation and either require a long cool-down period or use of a cooling gas to return the adsorbent material to a temperature at which adsorption can resume. Larger vessels require thicker walls to operate under pressure, increasing the cost and weight of the vessels and negatively impacting the heating and cool-down times. As the process of adsorption is exothermic, the adsorbent material must be cooled to a temperature no more than the maximum temperature at which adsorption occurs minus the exothermic temperature rise of the specific adsorbent material and the specific polar molecules before adsorption can resume. With these constraints, it is not uncommon for the entire TPD cycle (heating, desorption and cooling) to take hours and can take in excess of a day. While the aforementioned processes (PSA and TPD) are used in industry, both individually and in combination, a faster desorption process would allow the use of smaller adsorption beds, consume less energy and minimize required material for the construction of adsorber vessels. All of these reduce capital cost, operating cost, weight and footprint.

Microwave based desorption is one such faster desorption process, but has technical implementation issues in pressurized vessels, does not uniformly heat the adsorbent material, is complex, has a limited life of the microwave source, and is currently expensive.

A solution is therefore needed to address the issues presented by the current state of the art. It would be ideal if such a solution also does not result in degradation of the adsorbent material and has a long life of the energy source, thereby minimizing service requirement over the life of the system.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

Methods and apparatus are described for removing adsorbed polar molecules from an adsorbent material using radio frequency energy. Applications include, but are not limited to, removing gaseous anhydrous NH₃ from an adsorbent bed in an NH₃ production system and removing NH₃ from an adsorbent bed in an NH₃ cracking system. In some embodiments, desorbed polar molecules can be extracted from a bed of adsorbent material using radio frequency energy combined with: i) a pressurized gas comprised of the desired polar molecules, ii) one (1) or more vacuum systems, iii) a non-adsorptive, or minimally-adsorptive sweep gas, or iv) a combination thereof. Other techniques as described herein can also be combined with the application of RF energy to carry out polar molecule desorption.

### BRIEF DESCRIPTION OF THE DRAWINGS

Non-limiting and non-exhaustive embodiments of the disclosed systems and methods, including the preferred embodiment, are described with reference to the following figures, wherein like reference numerals refer to like parts throughout the various views unless otherwise specified.

FIG. 1 is a table of frequencies and permitted bandwidths allocated for industrial use as defined by International Telecommunications Union (ITU) Radio Regulation and available to be used for radio frequency dielectric heating (and other uses) without special permission by various national telecommunications authorities. These ISM bands (Industrial, Scientific and Medical) largely follow this table throughout the world, although there are some exceptions (for example, 896 MHz is used instead of 915 MHz in the United Kingdom).

FIG. 2 is a depiction of thermally programmed desorption (TPD) curves of NH₃ for commercial and hierarchical ZSM-5 zeolites. Other zeolites demonstrate similar temperature desorption performance although the number, magnitude and temperature location of desorption peaks are different.

FIG. 3 is a depiction of the percentage of desorbed NH₃ for commercial and hierarchical ZSM-5 zeolites as the temperature is increased from 0° C. to 600° C.

FIG. 4 is a graph of temperatures incurred as a result of the exothermic reaction during adsorption of NH₃ in 13X zeolite, as measured at three (3) locations within a zeolite bed along the direction of NH₃ flow. This figure also depicts the subsequent cooling of the three (3) locations after maximum adsorption has occurred.

FIG. 5 is a graph showing the temperature range and rate of desorption at three (3) locations within a zeolite bed along the direction of a N₂ sweep during a power limited radio frequency desorption process as disclosed herein.

FIG. 6 is a depiction of the desorption curve of NH₃ showing the asymmetric sigmoidal relationship of adsorption rate and time for a constant flow of NH₃ out of a zeolite adsorbent bed.

FIG. 7 is a graph depicting Paschen's Law, an equation that gives the breakdown voltage (the voltage necessary to start a discharge or electric arc) between two (2) electrodes in a gas as a function of pressure and gap length (pd, in Torr cm), as it specifically applies to Helium (He), Argon (Ar), Neon (Ne), Hydrogen (H₂), and Nitrogen (N₂).

FIG. 8 is a graph depicting Paschen's Law, as it specifically applies to NH₃ gas.

FIG. 9 is a NH₃ Phase State diagram depicting the phase of NH₃ (i.e., gas, liquid, or solid), depending upon pressure and temperature.

FIG. 10 is a side cross-sectional schematic illustration of an adsorber vessel assembly for removing NH₃ from an adsorbent material according to various embodiments described herein.

FIG. 11 is a top view illustration of an adsorber vessel assembly for removing NH₃ from an adsorbent material according to various embodiments described herein.

FIG. 12 is a schematic illustration of a balanced radio frequency energy generator configured in accordance with various embodiments described herein and configured for use in conjunction with various embodiments described herein.

FIG. 13 is a schematic illustration of an unbalanced radio frequency energy generator configured in accordance with various embodiments described herein and configured for use in conjunction with various embodiments described herein.

FIG. 14 is a schematic illustration of an unbalanced radio frequency impedance matching circuit (coupling circuit) with a variable impedance transfer function configured in accordance with various embodiments described herein and configured to interface a radio frequency energy generator to the electrodes of the adsorber vessel assembly according to various embodiments described herein.

FIG. 15 is a schematic illustration of the interconnection of the control system, radio frequency energy generator and adsorber vessel assembly for removing polar molecules from an adsorbent material according to various embodiments described herein.

FIG. 16 is a schematic illustration of a system for removing specific polar molecules from an adsorbent material utilizing a gas that consists of the desired specific polar molecules for adsorber vessel assembly pressurization, combined with complete (or substantially complete) capture of residual system process gas, configured in accordance with various embodiments described herein.

FIG. 17 is a schematic illustration of a system for removing specific polar molecules from an adsorbent material utilizing a gas that consists of the desired specific polar molecules for adsorber vessel assembly pressurization, combined with partial capture of residual system process gas, configured in accordance with various embodiments described herein.

FIG. 18 is a schematic illustration of a system for removing specific polar molecules from an adsorbent material utilizing a deep vacuum of the adsorber vessel assembly, combined with complete (or substantially complete) capture of residual system process gas, configured in accordance with various embodiments described herein.

FIG. 19 is a schematic illustration of a system for removing specific polar molecules from an adsorbent material utilizing a deep vacuum of the adsorber vessel assembly, combined with partial capture of residual system process gas, configured in accordance with various embodiments described herein.

FIG. 20 is a schematic illustration of a system for removing specific polar molecules from an adsorbent material utilizing a sweep gas through the adsorber vessel assembly, combined with complete (or substantially complete) capture of residual system process gas, configured in accordance with various embodiments described herein.

FIG. 21 is schematic illustration of a system for removing specific polar molecules from an adsorbent material utilizing a sweep gas through the adsorber vessel assembly, combined with partial capture of residual system process gas, configured in accordance with various embodiments described herein.

FIG. 22 is a schematic illustration of an unbalanced radio frequency impedance matching circuit (coupling circuit) with a fixed impedance transfer function configured in accordance with various embodiments described herein and configured to interface a radio frequency energy generator to the electrodes of the adsorber vessel assembly according to various embodiments described herein.

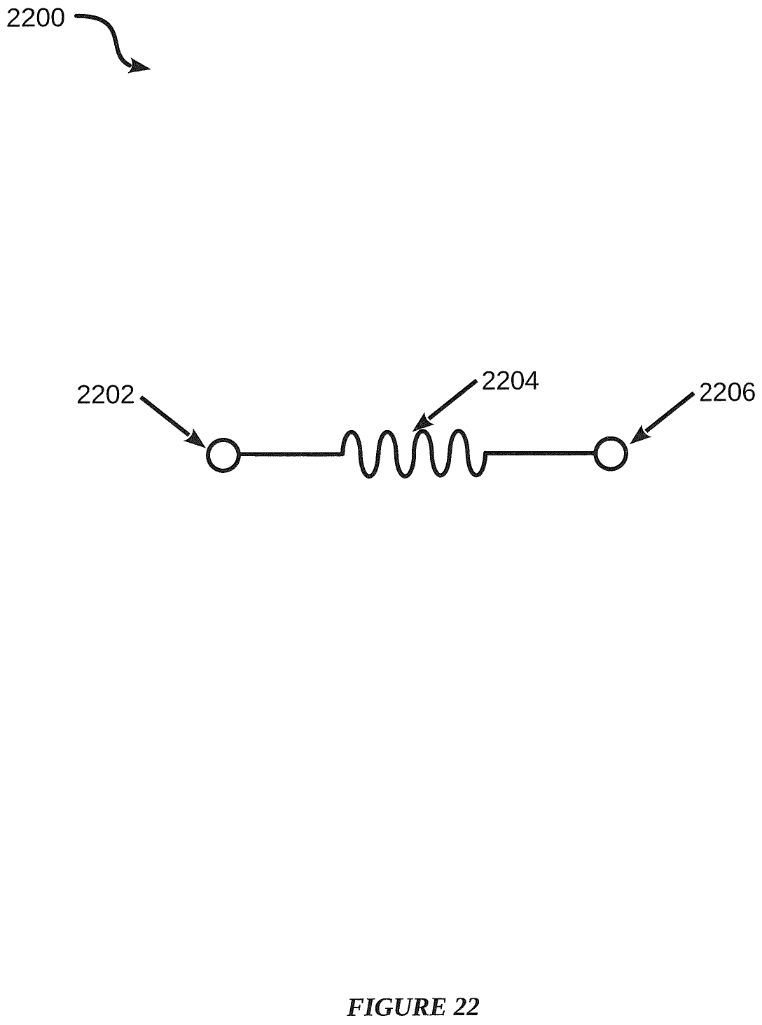

### DETAILED DESCRIPTION

Embodiments are described more fully below with reference to the accompanying Figures, which form a part hereof and show, by way of illustration, specific exemplary embodiments. These embodiments are disclosed in sufficient detail to enable those skilled in the art to practice the technology described herein. However, embodiments may be implemented in many different forms and should not be construed as being limited to the embodiments set forth herein. The following detailed description is, therefore, not to be taken in a limiting sense.

U.S. Pat. No. 10,787,367, entitled “Removal of Gaseous NH₃ from an NH₃ Reactor Product Stream”, describes, among other things, various embodiments of a method for harvesting gaseous NH₃ from a NH₃ reactor product stream using an adsorbent material. For example, NH₃ gas can be removed from a gas mixture such as H₂+N₂+NH₃ by passing the mixture through an adsorption bed composed of NH₃ adsorbing material such as type 4 Å (4 ångströms) molecular sieve, type 5 Å (5 ångströms) molecular sieve, type 13X molecular sieve, or others. The NH₃ adsorbs to the molecular sieve in preference to the H₂ and N₂, with the net effect that the H₂ and N₂ pass through the bed while the NH₃ stays attached to the adsorbent material. In addition to NH₃, 4 Å molecular sieves can adsorb water (H₂O) and other molecules with less than a 4 Å critical diameter, such as dinitrogen sulfide (N₂S), sulfur dioxide (SO₂), carbon dioxide (CO₂), ethanol (C₂H₅OH), ethane (C₂H₆) and ethylene (C₂H₄). As with 4 Å molecular sieves, type 5 Å molecular sieves adsorb molecules with less than a 5 Å critical diameter. While molecular sieves are produced in different shapes and sizes, spherical beads are sometimes preferred as: i) they present a lower back-pressure to the flow of gasses, ii) their shape creates a higher crush strength, iii) they do not have sharp edges and therefore minimize attrition as the beads move relative to one another and iv) the bulk density is higher.

Spherical beads of equal size can pack a given area with a packing density ranging from approximately 59% of volume to approximately 74% of volume, based upon the method of packing, e.g., loose random, poured random, close random and dense regular packing using face-centered cubic (FCC) or hexagonal close-packed (HCP) methods. Mixing spherical beads of two (2) or more diameters can result in packing density as high as approximately 91%. Increases in packing density result in smaller adsorber vessels for equivalent production, but it should be noted that as the packing density of the adsorbent material increases the back pressure of gas flow through the adsorbent material increases as well. This increase in back pressure can be addressed by a more powerful compressor to circulate the process gas through the adsorber vessel, but at an increase in required power. This compressor is outside the apparatus and methods described herein, but an implementer of the technology described herein should be aware of this relationship.

Regardless of the packing density achieved, when processing a gas combination (process gas+desired polar molecules) through an adsorbent material in spherical bead form, the volume of residual process gas remaining in the adsorber vessel (PGV) is equal to the adsorber vessel volume (AV_{V}) times the quantity of 100% minus the packing density (P_{D}) of the adsorbent material. This is illustrated in the following equation (3):

PGV=AV_{V}*(100−P_{D}) (3)

The residual process gas, remaining in the space between the adsorbent material spherical beads, is referred to herein as interstitial gas.

In order for the polar molecules released from the adsorbent material to be as pure as necessary for the intended application, it is desirable to remove the interstitial gas along with any remaining process gas residing in the adsorber vessel and/or associated plumbing, prior to desorption of the adsorbent material, regardless of the methodology of desorption.

U.S. Pat. No. 10,787,367 describes removing adsorbed NH₃ from an adsorbent material using a thermally-driven temperature and pressure swing process. This application, in contrast, describes using radio frequency energy (optionally in combination with vacuum vessels, vacuum pumps, or vacuum vessels and vacuum pumps) to remove polar molecules, such as NH₃, from the adsorbent material. This is possible as polar molecules are not electrically conductive, but vibrate in the presence of the alternating radio frequency energy electrical field, thus providing vibrational energy, which also produces thermal energy (heating). The radio frequency energy does not readily interact with the adsorbent material, so the vibrational energy and thermal energy impacts are dependent upon the polar molecules adsorbed within the adsorbent material. For that reason, radio frequency energy is only applied to the adsorbent material when it contains a sufficient quantity of polar molecules to receive, and respond to, the radio frequency energy. For the purpose of the description of the invention and the embodiments enumerated, radio frequency energy and radio frequency energy electrical field are used interchangeably.

### Specific Polar Molecule Desorption by Radio Frequency Energy

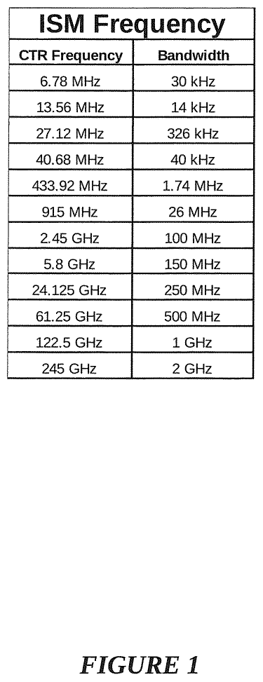

In some embodiments described herein, a method of desorbing polar molecules from an adsorbent material generally comprises exposing the adsorbent material having the polar molecules contained therein to radio frequency energy. Any suitable type of radio frequency energy can be used, including at any suitable frequency. In some embodiments, the frequency of the radio frequency energy used in the methods described herein is one (1) or more of the frequencies shown in FIG. 1 (the frequencies typically used in international applications of radio frequency dielectric heating). However, it should be appreciated that other frequencies, such as any frequency from 3 kilohertz to 300 gigahertz, can also be used in the methods described herein.

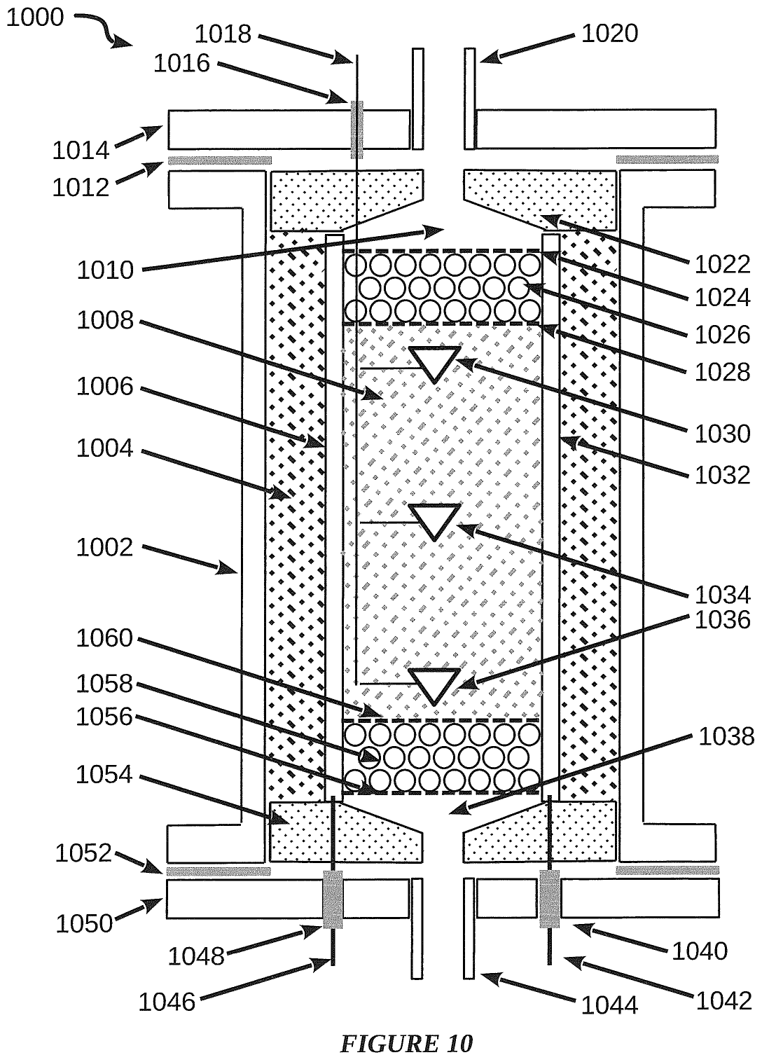

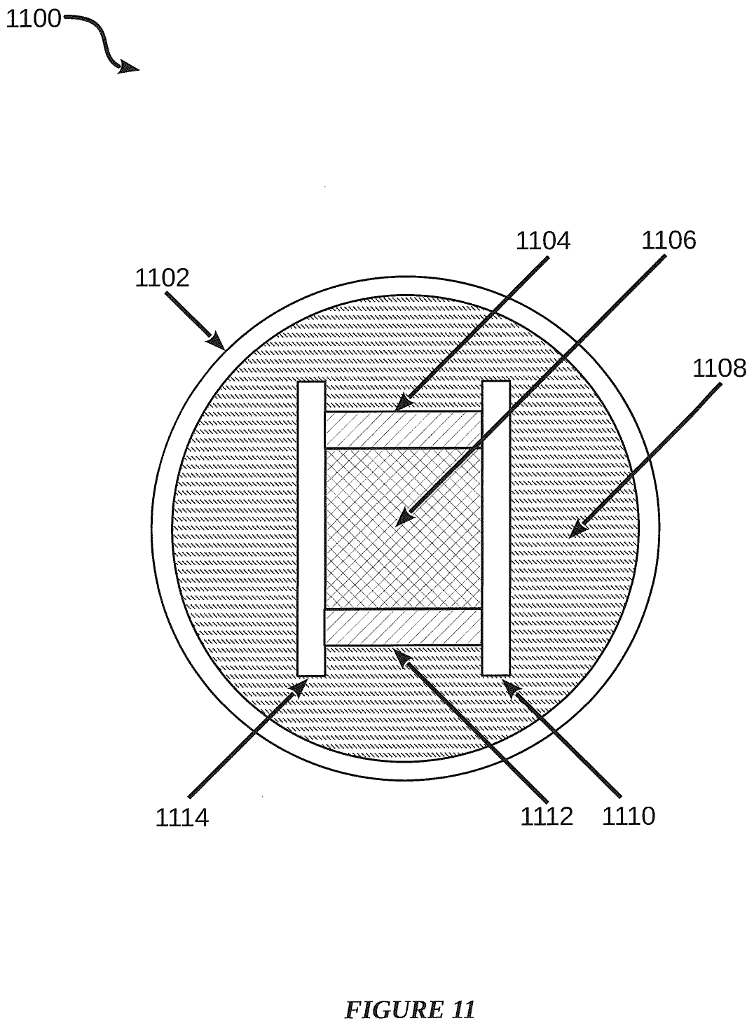

One specific manner of directing radio frequency energy at an adsorbent material loaded with adsorbed polar molecules is to place the adsorbent material between a pair of electrically conductive metal plates to which the radio frequency energy is applied. Specific configurations of sources of radio frequency energy relative to the location of the adsorbent material are described in further detail below with respect to, e.g., FIGS. 10 and 11. It should also be appreciated that multiple configurations can be used to improve the removal of NH₃ from the adsorbent material. For example, a method may include applying radio frequency energy to an adsorbent material with different size plates and at different spacing between the metal plates.

The amount of time that the adsorbent material is exposed to radio frequency energy in the methods described herein may be a function of the physical arrangement of the metal plates, the power level of radio frequency energy applied, the composition of the adsorbent material, the polar molecules adsorbed therein and/or the temperature of the adsorbent material. In some embodiments, the radio frequency energy may be applied to the adsorbent material for any period of time that removes some, but not all, of the polar molecules from the adsorbent material, subject to the pressure within the adsorber vessel.

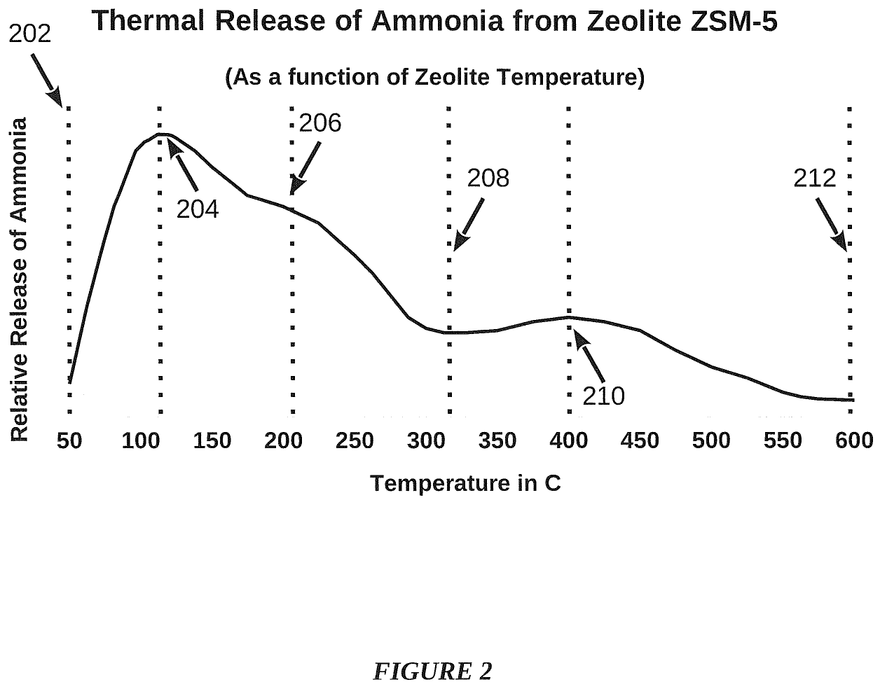

It is known in the art that adsorbent materials have different energy level bond sites that contain the adsorbed polar molecules, as shown in FIG. 2. Generally, these different energy sites are characterized as low energy sites and high energy sites. FIG. 2 shows an example of the relative release (desorption) of the polar molecule NH₃, adsorbed within a bead bed comprising the adsorbent material ZSM-5, as the temperature of the adsorbent material is increased from 50° C. to 600° C. Desorption starts at temperature point 202, approximately at 50° C. Desorption increases rapidly as the temperature of the adsorbent material is increased, to temperature point 204, approximately 125° C., which is the point of release of the weak bonds between the adsorbent material and the polar molecules. As the temperature of the adsorbent material is increased, a second bond energy area is encountered at temperature point 206, approximately 200° C. As the temperature of the adsorbent material is increased further, a dip or local minimum desorption point is encountered at temperature point 208, approximately 320° C. Increasing the temperature of the adsorbent material beyond this point, the release point of the strong bonds is reached at temperature point 210, approximately 400° C. Finally, additional increase of temperature to temperature point 212, approximately 600° C. results in the release of approximately 98% of the polar molecules previously adsorbed in the adsorbent material. It is important to note that the desorption curve depicted is dependent upon the specific composition of the adsorbent material, the specific polar molecules, the quantity of the polar molecules adsorbed within the adsorbent material, the distribution of weak and strong bond points, and the deviation of the bond energies and associated temperature points.

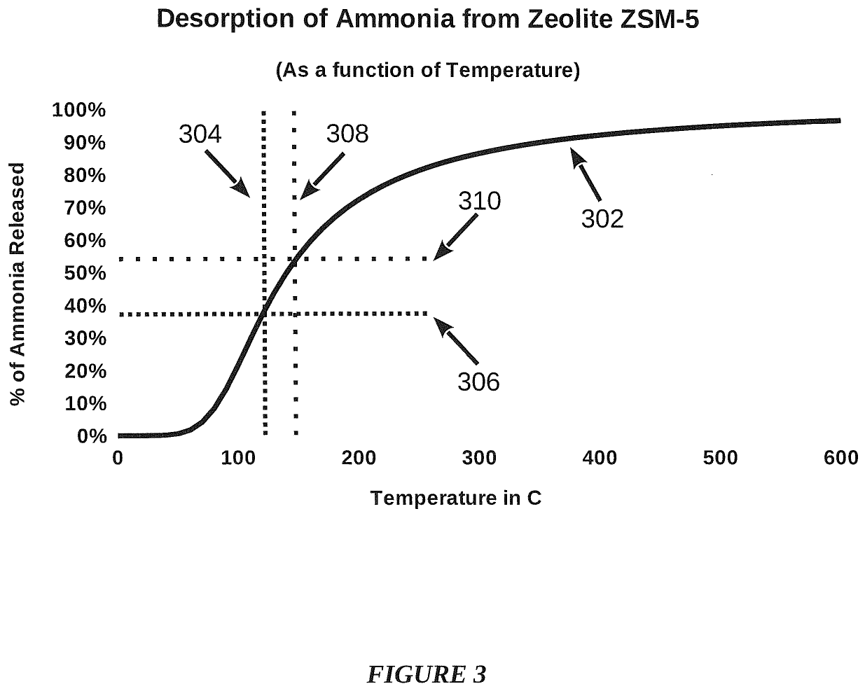

Integrating the data used to produce the curve shown in FIG. 2 with respect to temperature, and fitting a curve to the results of the integration, curve 302, shown on FIG. 3, is produced. Curve 302 represents the percentage of the polar molecules NH 3 contained within the adsorbent material ZSM-5 that have been released when the adsorbent material has reached a given temperature. As can be seen in FIG. 3, at the point where the adsorbent material has reached temperature point 304, approximately 125° C., approximately 38% of the polar molecules have been released (percentage point 306). Furthermore, at the point where the adsorbent material has reached temperature point 308, approximately 150° C., approximately 53% of the polar molecules have been released (percentage point 310). Therefore, it is possible to rapidly release a useful percentage of the polar molecules contained within the adsorbent material at a relatively low temperature. In this case, the relatively low temperature is at or below 150° C. Given the non-linearity of curve 302 and a constant rate of temperature increase as driven by a constant energy source, the time to release a specific amount of polar molecules increases as the percentage of polar molecules released increases. In the case of the example shown on FIG. 3, to achieve a percentage desorption of 95%, with a rate of temperature increase of 3° C. per minute, requires a total time of desorption of approximately 195 minutes and results in an adsorption material final temperature of approximately 584° C.

To achieve a percentage desorption of 40%, with the same rate of temperature increase, requires a total time of desorption of approximately 43 minutes and results in an adsorption material final temperature of approximately 128° C. The lower final temperature of the adsorbent material during desorption allows for a shorter cooling time. Combined with the shorter desorption time, this facilitates the ability to have multiple cycles of heating, desorption and cooling in the time required by one such cycle using the traditional TPD method.

Keeping the maximum temperature of the adsorbent material relatively low is particularly important for three (3) reasons: i) it significantly reduces the total energy (in Joules) required for desorption, ii) it reduces the cycle time of desorption/adsorption, and iii) it prevents degradation of the adsorbent material. As can be deduced from FIG. 3, it is possible to utilize a concatenated sequence of low temperature cycles comprised of desorption and adsorption phases in place of a single high temperature cycle, thus accruing the aforementioned benefits.

It is noted that while curve 302 shows the behavior of the adsorbent material ZSM-5 and polar molecules of NH₃, different combinations of polar molecules and adsorbent materials will result in different temperature desorption curves.

Historically, polar molecules are released by thermal energy, that is, elevating the adsorbent material to a sufficiently high temperature until all, or most, of the polar molecules are discharged. This results in heating of the adsorbent material and the vessel in which the adsorbent material is contained to a relatively high temperature and requires a significant application of energy over a long period of time. It should be realized that it is not practical to thermally remove 100% of the polar molecules adsorbed within the adsorbent material due to the time and energy required.

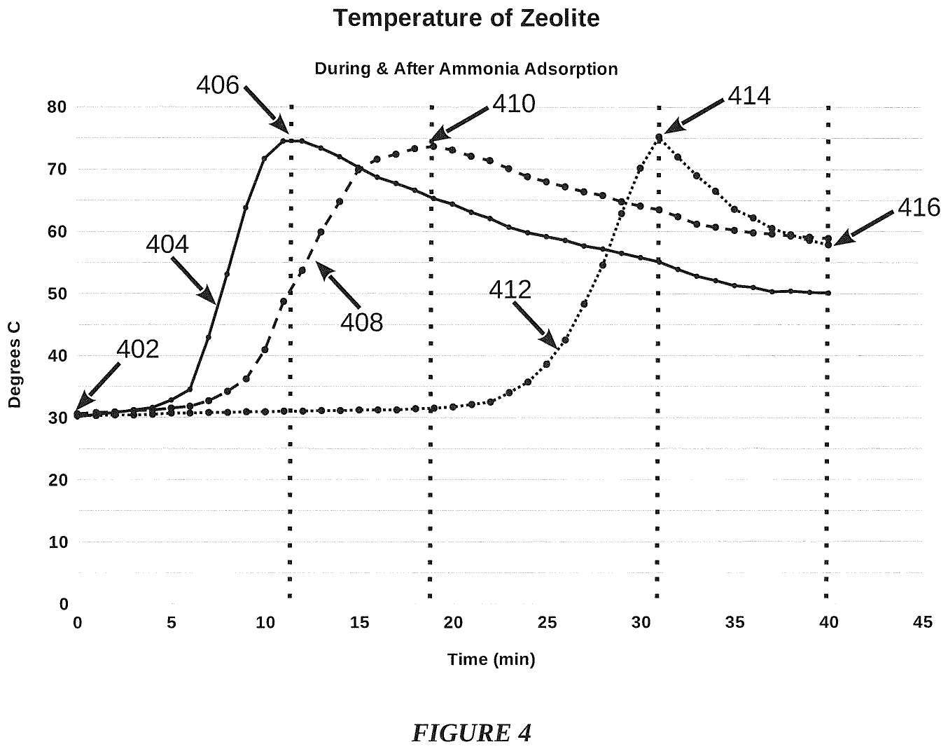

Once the adsorbent material and/or its containment vessel are heated, it is necessary to allow these elements to cool until the adsorbent material is below the temperature at which adsorption occurs. For the process to not be self-limiting, the temperature to which the adsorbent is cooled needs to be no greater than the temperature at which adsorption stops minus the temperature rise of the adsorbent during the adsorption phase (the temperature rise created by the exothermic reaction). As shown on FIG. 4, the exothermic reaction of the adsorption of NH₃ by 13X zeolite results in a temperature rise of approximately 45° C. over ambient temperature under specific conditions (i.e., the polar molecules are pure gaseous NH₃ introduced into the adsorbent material at a rate of 1 liter per minute, with the initial temperature of the adsorbent material at 30° C. and the gas at the inlet to the adsorbent vessel at 18° C.). This temperature rise is unique and specific to the adsorption material, the polar molecules, the concentration of the polar molecules in the composite process gas stream (i.e., the process gas and polar molecules), the temperature of the composite gas stream, and the flow rate of the composite gas stream.

FIG. 4 further demonstrates the flow of heat through the adsorber vessel containing the adsorbent material Zeolite 13X as the process gas (in this case, a 1 liter/minute stream of pure polar molecules comprising 100% NH₃) traversed through the adsorber vessel. Three (3) fiber optic temperature probes were placed within the adsorbent material, with the first near the inlet of the adsorber vessel, the second between the inlet and the middle of the adsorber vessel and the third near the outlet of the adsorber vessel. The curves demonstrating the temperature of adsorption and subsequent cooling (post saturation) represented by the three (3) fiber optic temperature probes are 404, 408 and 412, respectively. The initial temperature of the adsorbent material, prior to the introduction of the stream of polar molecules, at test time=0 minutes, is approximately 30° C. (temperature point 402). All three (3) fiber optic temperature probes show materially the same maximum temperature of approximately 74.5° C., or a temperature rise over ambient of approximately 45.5° C. (temperature points 406, 410 and 414). The fiberoptic temperature probes also show the time distribution of the peaks as the exothermic activity propagates through the adsorbent material. The first fiber optic temperature probe, 404, peaks at approximately 11 minutes (temperature point 406) from start of test, at which point the adsorbent material located between the inlet and the first fiber optic temperature probe is saturated with NH₃. The exothermic reaction for this adsorbent material is now over and the aforementioned adsorbent material begins to cool. The second fiber optic temperature probe, 408, peaks at approximately 19 minutes (temperature point 410) from start of test, at which point the adsorbent material located between the inlet and the second fiber optic temperature probe, 408, is saturated with NH₃. The exothermic reaction for the adsorbent material between the inlet and the second fiber optic temperature probe, 408, is now over and the adsorbent material between the first and second fiber optic temperature probes, 404 and 408 respectively, begins to cool while the adsorbent material between the inlet and the first fiber optic temperature probe, 404, continues to cool. The third fiber optic temperature probe, 412, peaks at approximately 32 minutes (temperature point 414) from start of test, at which point the adsorbent material located between the inlet and the third fiber optic temperature probe, 412, is saturated with NH₃. The adsorbent material between the second and third fiber optic temperature probes, 408 and 412 respectively, begins to cool while the adsorbent material between the inlet and the first and second fiber optic temperature probes, 404 and 408 respectively, continues to cool. The adsorbent material between the third fiber optic temperature probe, 412, and the outlet will progress through adsorption with a corresponding temperature peak and subsequent cooling (not shown on FIG. 4). The time of this portion of the process is dependent upon the same factors associated with previous exothermic reactions combined with the amount of adsorbent material between the third fiber optic temperature probe, 412, and the outlet. The exothermic temperature rise and cooling test concludes at approximately 40 minutes (time point 416).

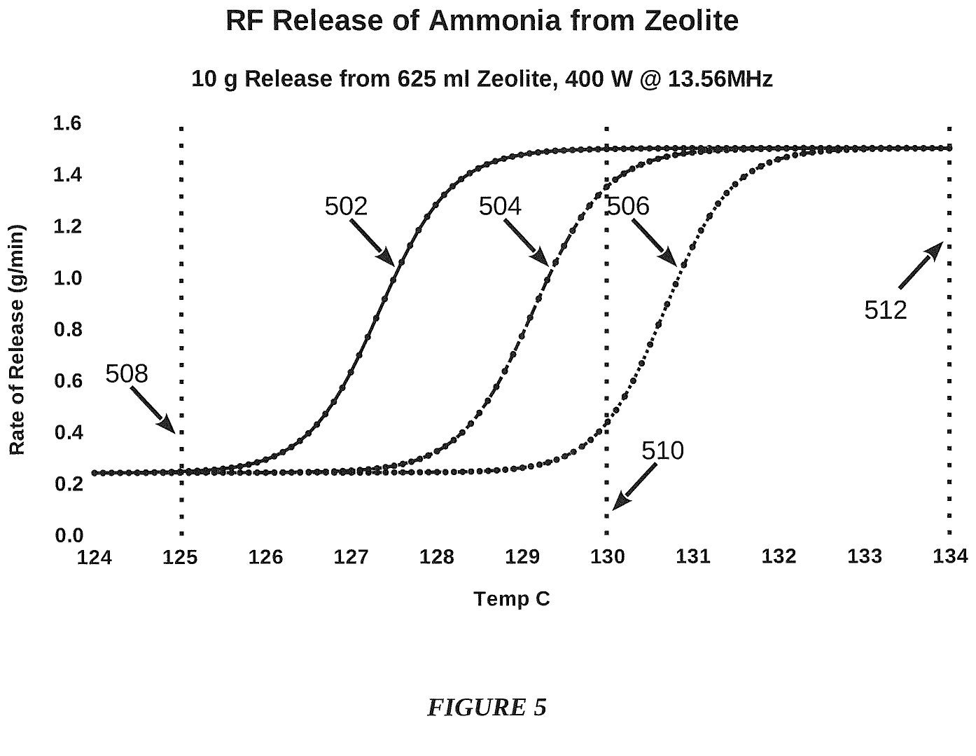

FIG. 5 demonstrates the radio frequency energy induced rate of desorption curve of the adsorbent material Zeolite 13X. In this case, the 625 milliliters of adsorbent material contained 36.25 grams of the polar molecule NH₃ (8.869 weight percent of 408.75 grams of adsorbent material, with 8.869 weight percent being the NH₃ capacity of this formulation of adsorbent material). The adsorber vessel was pressurized to 1.034 bar through the use of a N₂ sweep gas and downstream flow restriction. Three (3) fiber optic temperature probes were placed within the adsorbent material, with the first near the inlet of the adsorber vessel, the second near the middle of the adsorber vessel and the third near the outlet of the adsorber vessel. The desorption (rate of release) curves as a function of temperature represented by the three (3) fiber optic temperature probes are 502, 504 and 506, respectively. With a constant applied power of approximately 400 Watts at 13.56 MHz, the test desorbed approximately 10 grams of NH₃ from the 13X, representing a desorption of approximately 27.6 percent of total polar molecule (NH₃) capacity of the adsorbent material. Of particular note, as seen on curve 502, is that desorption did not materially begin until the adsorbent material reached a temperature of approximately 125° C. (temperature point 508) and reached a maximum flow of approximately 1.5 g/min when the temperature of the adsorbent material reached a temperature of approximately 130° C. (temperature point 510). The low flow rate of the N₂ sweep resulted in negligible cooling of the adsorbent material. However, as the N₂ sweep did direct the NH₃ from the adsorber vessel, the temperature of the desorbed NH₃ provided additional heating of the downstream adsorbent material. This resulted in the final temperature of the downstream adsorbent material at termination of the test (i.e., approximately 10 g NH 3 desorption) reaching approximately 134° C. (temperature point 512). Additional application of the approximately 400 watts of radio frequency energy would have resulted in continued heating of the adsorbent material beyond that necessary to remove the intended amount. It is of interest that the release of the polar molecules under a constant application of radio frequency energy followed an asymmetric sigmoidal curve.

Heating during desorption can be minimized by using only the average intensity of the radio frequency energy required to bring the temperature of the adsorbent material to that necessary to release the polar molecules from low energy sites. This can be achieved by either applying the radio frequency energy using pulse width modulation to present a number of cycles in a burst followed by a quiescent period and repeating this sequence as required, or preferably, by amplitude modulation (variable continuous power). While the number of cycles in the burst can be a fractional number and can be initiated without respect to the phase of the radio frequency energy, it may be preferable to utilize an integer number of cycles and to initiate and terminate the burst of cycles at the zero cross of the radio frequency energy (i.e., phase angles of 0° and 180°) in order to minimize harmonic radio frequency energy. This, however, does not eliminate the harmonic radio frequency energy generated by the burst process itself.

While not wishing to be bound by theory, a possible explanation for a portion of the desorption effect radio frequency energy exhibits when applied to an adsorbent material containing polar molecules is that the dipole moment of the adsorbed polar molecules is large enough that the radio frequency energy can cause the molecule to twist or rotate on the adsorbent surface with sufficient force or energy to break the adsorption bonding and free the molecule from the surface.

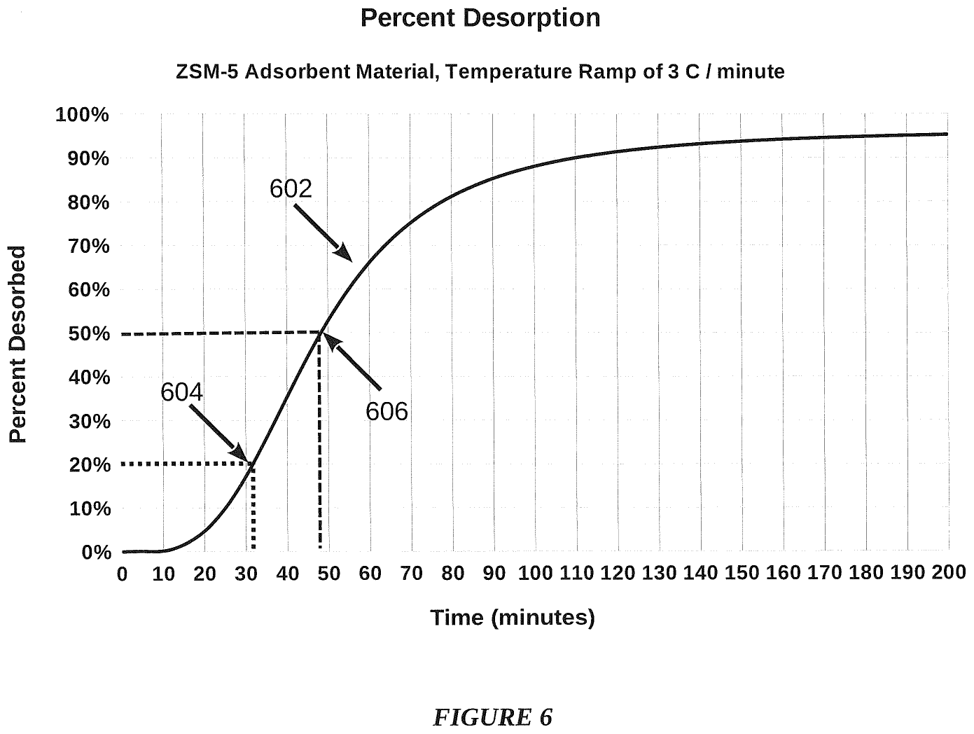

FIG. 6 shows curve 602, which depicts the asymmetric sigmoidal percent desorption of the adsorbent material ZSM-5 which is saturated with the polar molecule NH₃. In this case, the vertical axis is the percent of desorption and the horizontal axis is time in minutes (based upon a temperature ramp rate of 3° C. per minute). It is noted that there is a portion of curve 602 in which the slope of the curve is nearly linear, between points 604 and 606. There are several key points to take from this observation: i) the percentage of polar molecules released per unit of time (i.e., the rate of desorption) drops quickly above a desorption percentage of approximately 50% (point 606), ii) there is a floor, or minimum time to reach a meaningful desorption percentage, in this case approximately 20% (point 604), and iii) there is a region of operation in which significant desorption occurs for a minimal increase in time (i.e., between points 604 and 606).

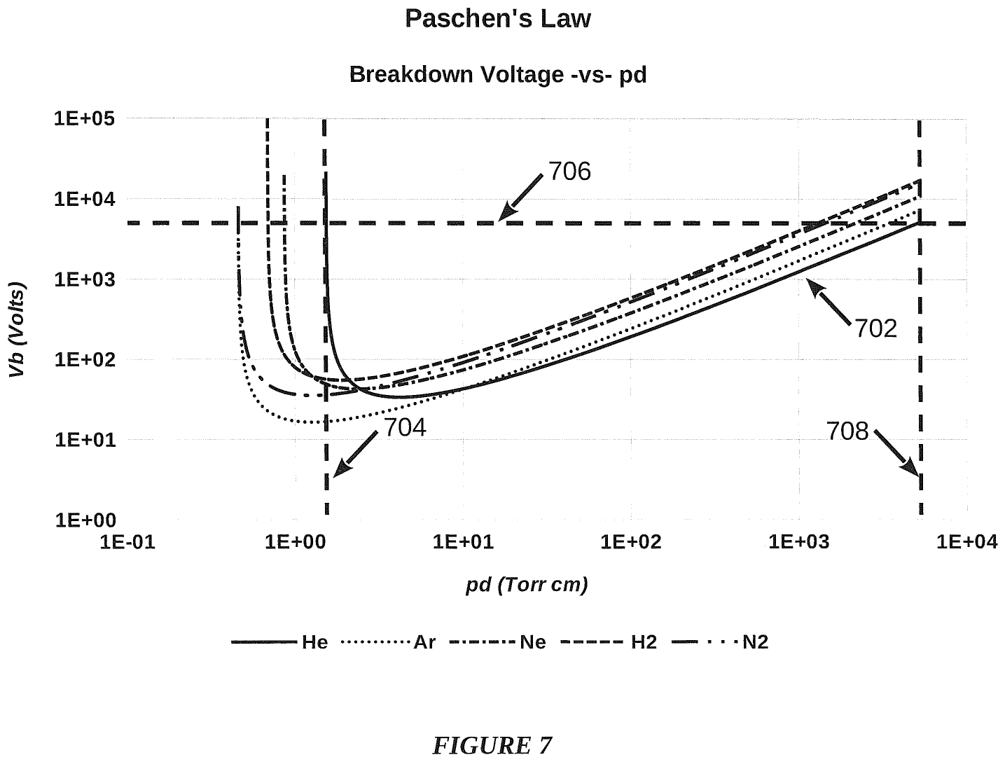

FIG. 7 shows a graphical representation of Paschen's Law for multiple gasses. This law, or equation, computes the breakdown voltage (i.e., the voltage necessary to start an arc) between two parallel metal plates, or electrodes, in a gas as a function of pressure and gap distance. As can be seen in FIG. 7 (looking at the curve from right to left), with a constant gap length, the voltage at which an arc will occur decreases as the pressure is reduced, reaches a minimum, and then increases rapidly, ultimately exceeding the initial value. This curve is unique for a given gas, and curves for He, Ar, Ne, H₂, and N₂ are shown.

Paschen's Law is illustrated in the following equation (4):

$$V b = Bpd / ln ( Ap d ) - ln [ ln ( 1 + 1 / γ se ) ] \qquad ( 4 )$$

Where:
Vb is the breakdown voltage in volts,
B is a gas-specific constant related to the excitation and ionization energies,
p is the pressure in pascals,
d is the gap distance in meters,
A is a gas specific constant representing the saturation ionization in the gas at a particular E/p (electric field/pressure), and
γse is the secondary-electron-emission coefficient.

As an example, FIG. 7 shows the Paschen's Law curve for He, curve 702. Line 704 marks the point at which the breakdown voltage of He rises rapidly once the pressure-distance (pd) is less than approximately 1.5E+00 Torr cm. If the desired minimum breakdown voltage is approximately 4E+03 volts (line 706), the required pressure-distance (pd) at a higher pressure-distance point must be at least approximately 5E+03 Torr cm (line 708). Thus, given a fixed distance between electrodes in the adsorber vessel, it is possible to operate at a relatively low pressure, or a relatively high pressure, but not in-between these two points. While the curves for different gasses are similar, these curves must be evaluated for each of the gasses present in the adsorber vessel. The voltage applied across the electrodes can be rather high, on the order of a few thousand volts to above 10,000 volts, and is a function of the power level in watts of the radio frequency energy applied, the volume of adsorbent material within the adsober vessel, the dielectric constant of the adsorbent material (which varies depending upon the quantity of specific polar molecules that are adsorbed within the adsorbent material), the dimensions of the electrodes, and the distance between the electrodes.

In order for the polar molecules released from the adsorbent material to be as pure as necessary for the intended application, it is desirable to remove as much residual process gas, or gasses, as possible prior to driving the polar molecules from the adsorbent material. If this is done insufficiently, the pressure within the adsorber vessel can be such that the breakdown voltage, as determined by the combination of the pressure and distance between electrodes and the voltage applied across the electrodes, becomes too low for the application of radio frequency energy and will result in arcing within the adsorber vessel. The arcing can damage any combination of one (1) or more electrodes, the adsorber vessel, and the adsorbent material. In applications in which the process gases comprise 02 and one or more flammable and/or combustible gasses, this arcing can result in ignition and/or explosion. The radio frequency energy desorption methods and systems described herein address this issue and prevent arcing.

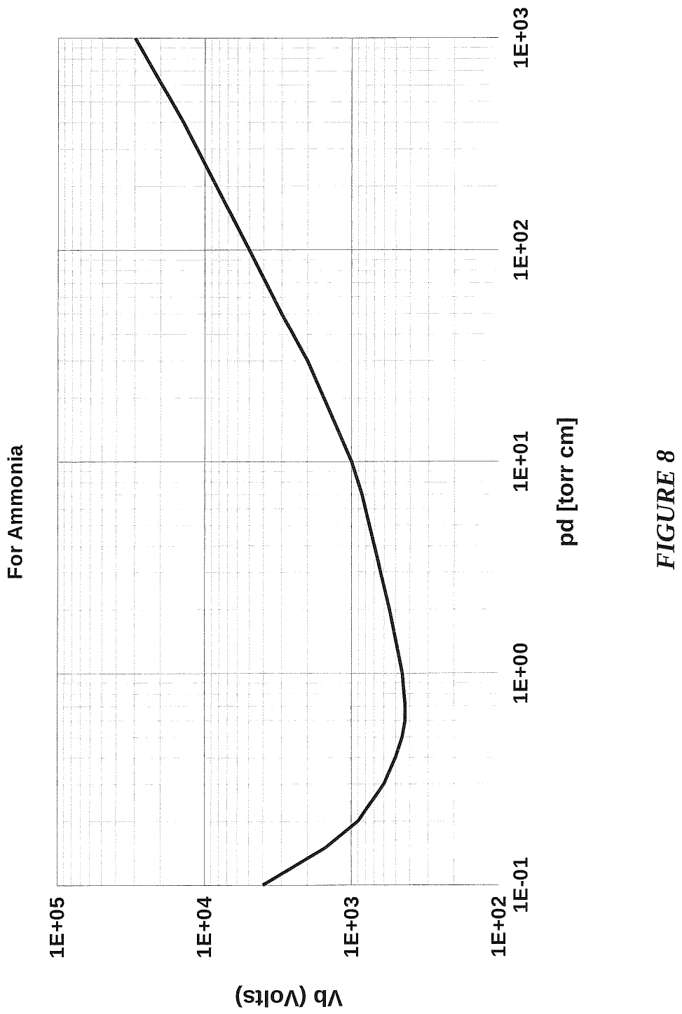

FIG. 8 shows a particular case of Paschen's Law when the gas is NH₃.

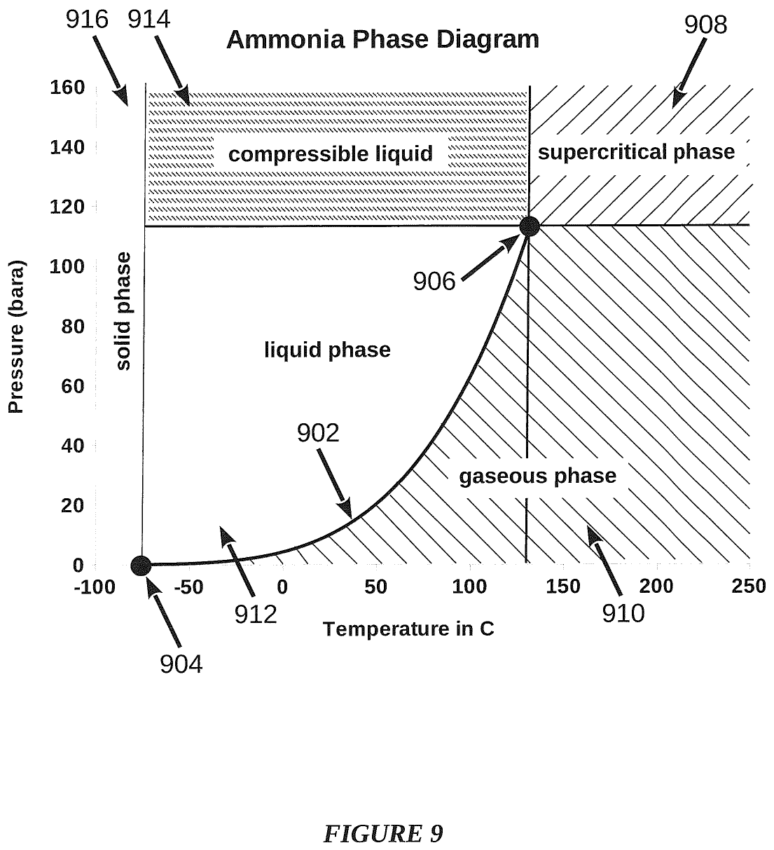

In certain conditions, it is possible to have a rate of temperature increase of the adsorbent material during desorption that exceeds 3° C. per minute, and even exceeds a rate of temperature increase of 10° C. per minute. To achieve this, it is necessary to assure that the polar molecules contained in the adsorbent material remain in a gaseous state throughout the adsorption and desorption process as well as during any period in which system power is removed. FIG. 9 shows a phase diagram for a particular polar molecule, NH₃. The vertical axis is pressure in bara and the horizontal axis is temperature in ° C. Curve 902 combined with the triple point (904) and the critical point (906) represent the boundaries of state changes of the substance. It is noted that all pure substances have a unique phase diagram.

At temperatures above the triple point (904) and at pressures below that of the critical point (906) but at temperatures greater than the temperature and at or lower than the pressure values identified by curve 902, the substance is in the gaseous phase (area 910). This area of the phase diagram is of particular interest for rapid radio frequency energy desorption.

It is noted that when the ambient temperature of a system is sufficiently low, in the absence of power, to allow the polar molecules phase state to be either the liquid phase or solid phase, the adsorbent material must be heated slowly, below a temperature ramp rate at which the adsorbent material would be damaged, typically at or below 3° C. per minute, until the polar molecules are in the gaseous phase. In the case in which the polar molecules expand transitioning from the liquid phase to the solid phase, such as in the case of H₂O, the adsorbent material and polar molecules must not be allowed to reach temperatures that would support the transition of the polar molecules to the solid phase. It is generally advisable to maintain the polar molecules in the gaseous phase.

The radio frequency energy desorption methods described herein can offer much faster adsorbent regeneration times than traditional thermal regeneration because the adsorbent material does not readily absorb radio frequency energy. As previously mentioned, the radio frequency energy is only absorbed by the polar molecules, which concentrates the radio frequency energy on the adsorbed polar molecules instead of dispersing it through the entire mass of the adsorption bed. This concentration of the energy on the polar molecules causes them to detach from the surface much more quickly than if thermal energy had to conduct through the entire adsorption bed, which has very poor thermal conductivity. It should be noted that the process of exciting the polar molecules with radio frequency energy results in a temperature increase of the adsorbent material. This temperature increase can be controlled by modulating the average output power of the radio frequency generator to prevent excessive heating of the adsorbent material.

FIG. 10 shows a cross-sectional view of an embodiment of an adsorber vessel assembly 1000 configured in accordance with the technology described herein. The adsorber vessel assembly 1000 has a generally elongated cylindrical shape with the longitudinal axis of the adsorber vessel assembly 1000 being oriented generally vertically. However, it should be appreciated that other adsorber vessel shapes and orientations may be used. The adsorber vessel assembly 1000 is contained in the vessel body 1002. Within the vessel body 1002 and adjacent to the interior walls of the vessel body 1002 is the insulation material 1004, which forms a thermal and gas barrier between the vessel body 1002 and the radio frequency desorption area, bounded in this view, by the electrodes 1006 and 1032. The insulation material 1004 also serves to minimize the quantity of process gas contained within the adsorber vessel assembly 1000. Between the electrodes 1006 and 1032 is the adsorbent material 1008. Screens 1028 and 1060 secure the adsorbent material 1008 in the vertical direction while allowing gas to flow through the adsorbent material 1008. Positioned within the adsorbent material 1008 is one or more temperature sensors 1030, 1034, and 1036. Positioned above and below screens 1028 and 1060, respectively, are areas of non-reactive beads 1026 and 1058 used to assure an equal flow of process gas throughout the adsorbent material 1008, which therefore receives a uniform distribution of polar molecules. The non-reactive beads 1026 and 1058 are held captive by the screens 1024 and 1056. Areas 1010 and 1038 transition the circular inlet 1020 and circular outlet 1044 into the rectangular shape between the electrodes 1006 and 1032. This transition is facilitated by additional insulation material caps 1022 and 1054, which also form thermal and gas barriers and serve to minimize the quantity of process gas contained within the adsorber vessel assembly 1000. The adsorber vessel assembly 1000 is capped by the top blind flange 1014 and the bottom blind flange 1050, which close the top and bottom of the adsorber vessel assembly 1000, respectively. Inlet 1020 is attached to the top blind flange 1014 and outlet 1044 is attached to the bottom blind flange 1050. To prevent leaks, gaskets 1012 and 1052 seal the top blind flange 1014 and the bottom blind flange 1050, respectively. The connection(s) 1018 from temperature sensors 1030, 1034 and 1036 exit the top blind flange 1014 through the pass-through seal 1016. In a like manner, connections 1046 and 1042 to the two (2) electrodes 1006 and 1032 pass through the bottom flange 1050 through electrical feed-throughs 1048 and 1040. In operation, the adsorber vessel assembly 1000 is positioned in a vertical orientation with the flow of gasses into inlet 1020 and out the outlet 1044. The downward flow of gasses minimizes adsorbent material 1008 movement, or lifting, due to the flow of gas, which in turn helps prevent movement related attrition of the adsorbent material 1008. The vertical orientation of the adsorber vessel assembly 1000 serves, in addition to the areas of non-reactive beads 1026 and 1058, to prevent channelization of gasses.

FIG. 11 shows a top cut-away view of the adsorber vessel assembly shown in FIG. 10. The adsorber vessel assembly is identified by reference number 1100 in FIG. 11. Within the cylindrical vessel body 1102 and adjacent to the interior wall of the vessel body 1102 is the insulation material 1108. Electrodes 1114 and 1110 are spaced apart by non-conductive spacers 1104 and 1112. Contained within the rectangular or square area bounded by the electrodes 1114 and 1110 and non-conductive spacers 1104 and 1112 is the adsorptive material 1106.

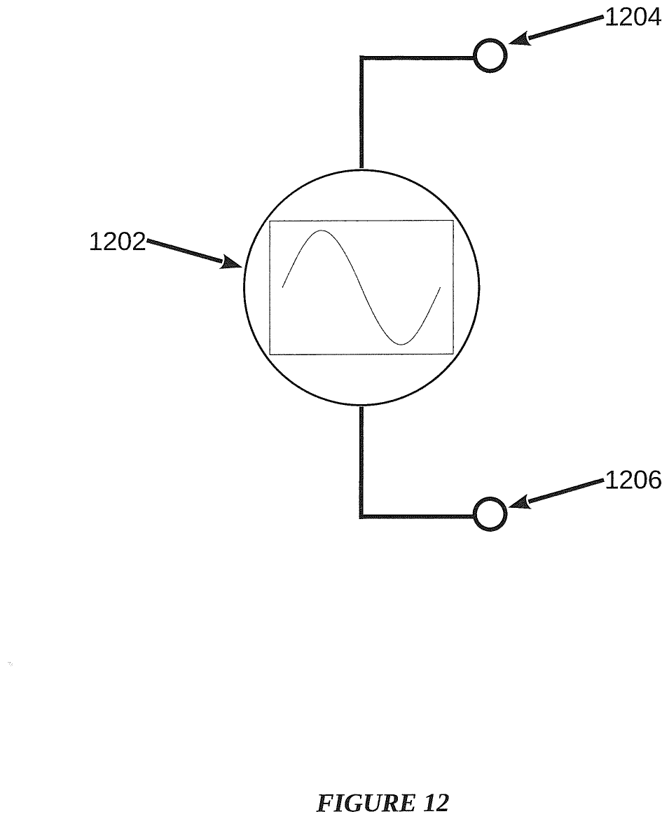

FIG. 12 shows a radio frequency generator 1202 with balanced output connections 1204 and 1206 configured in accordance with some embodiments described herein. The impedance presented by connections 1204 and 1206 can be an industry standard of 50 ohms and zero reactance, or some other impedance as may be practical, provided that the coupling circuit can match the output impedance of the radio frequency generator 1202 to that of the electrodes of the adsorber vessel assembly.

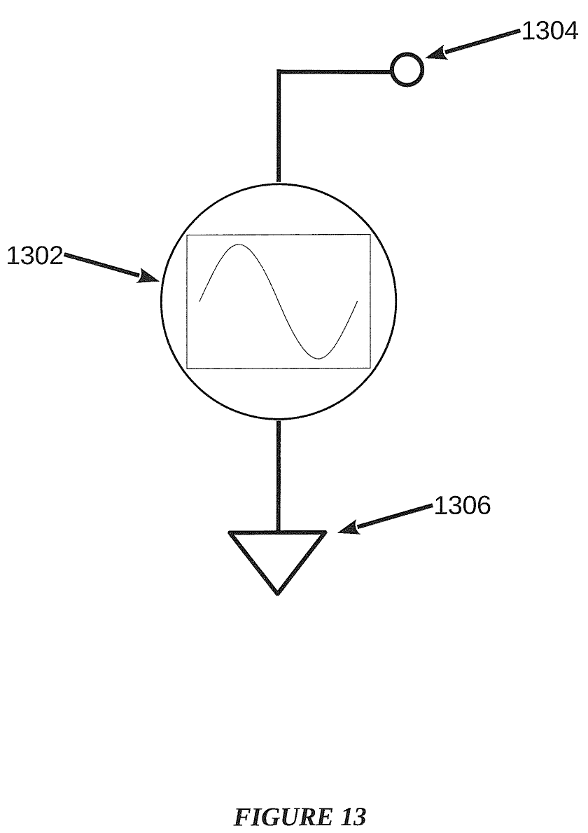

FIG. 13 shows a radio frequency generator 1302 with unbalanced output connection 1304 and grounded connection 1306 configured in accordance with some embodiments described herein. The impedance presented by the output connection 1304 relative to ground connection 1306 can be an industry standard of 50 ohms and zero reactance, or some other impedance as may be practical, provided that the coupling circuit can match the output impedance of the radio frequency generator 1302 to that of the electrodes of the adsorber vessel assembly.

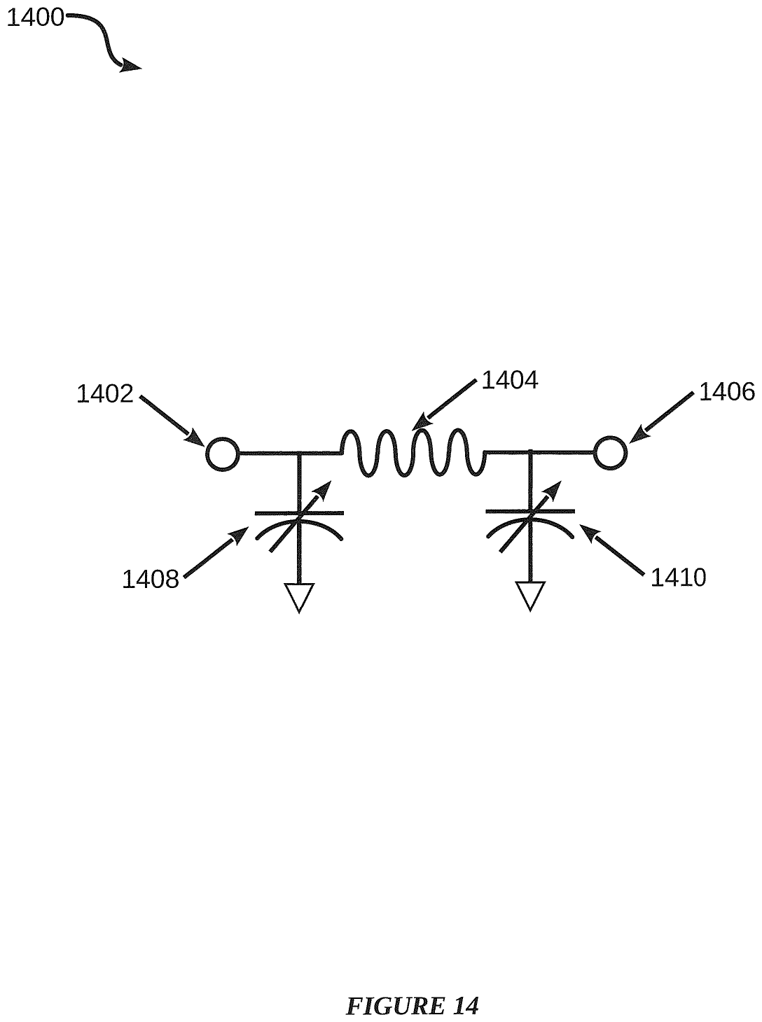

FIG. 14 shows a coupling circuit 1400 designed to match a radio frequency energy generator with an unbalanced output to the connections of the electrodes of the adsorber vessel assembly in accordance with some embodiments described herein. Input 1402 connects to the output connection of the unbalanced output of the radio frequency generator to one (1) side of capacitor 1408 and one (1) side of inductor 1404. The other connection of capacitor 1408 is grounded. The other connection of inductor 1404 feeds one (1) side of capacitor 1410 and the output connection 1406. The other side of capacitor 1410 is grounded. In this scenario, output 1406 feeds one (1) electrode of the adsorber vessel assembly and the other electrode of the adsorber vessel assembly is connected to ground. Capacitors 1408 and 1410 are adjustable to maintain impedance matching between the radio frequency energy generator and the electrodes of the adsorber vessel assembly as the impedance between the electrodes changes as polar molecules are removed from the adsorbent material. The coupling circuit 1400 is an unbalanced pi network configuration. Other configurations can also be utilized, including balanced and unbalanced configurations, and are well known in radio frequency art and therefore are not included in these figures.

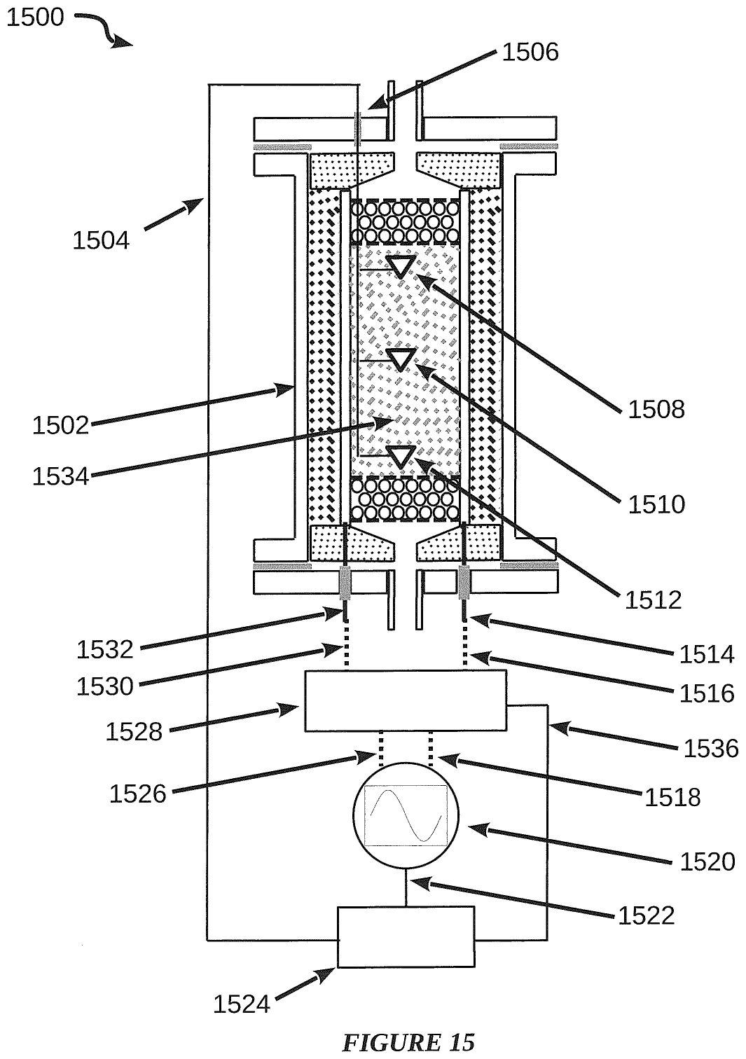

FIG. 15 shows a system configuration 1500 of the adsorber vessel assembly 1502 and the interconnections between the adsorber vessel assembly 1502, the control sub-system 1524, the connection 1522 between the control system 1524 and the radio frequency energy generator 1520, the radio frequency generator 1520 and the wires 1526 and 1518 connecting the radio frequency generator 1520 to the coupling circuit 1528, the coupling circuit 1528 and the wires 1530 and 1516 connecting the coupling circuit 1528 to the terminations of the electrodes 1532 and 1514 in accordance with some embodiments described herein. In addition, the system view 1500 of the adsorber vessel assembly 1502 shows the one (1) or more temperature sensors 1508, 1510, and 1512 with their connection(s) 1506 connecting to the control sub-system 1524 through the electrical or optical feedback path 1504 in accordance with some embodiments described herein. This system configuration 1500 permits the control sub-system 1524 to control the average output level and timing of application of radio frequency energy from the radio frequency generator 1520 through the coupling circuit 1528 and to the two (2) or more electrode terminations 1532 and 1514 for delivery of radio frequency energy into the adsorbent material 1534 located between the two (2) or more electrodes. In a version of the embodiment where the frequency of operation of the radio frequency generator 1520 is variable, control sub-system 1524 can adjust the frequency through connection 1522 to the radio frequency generator 1520. Feedback regarding the temperature of the adsorbent material 1534 is provided by the aforementioned one (1) or more temperature sensor 1508, 1510 and 1512 through the feedback path 1504. In a version of the embodiment in which coupling circuit 1528 provides a variable impedance transfer function, the control sub-system effects adjustment of the variable impedance transfer function through circuit 1536.

Radio Frequency Energy Desorption Apparatus and Method 1: Polar Molecule Fill with Process Gas Capture

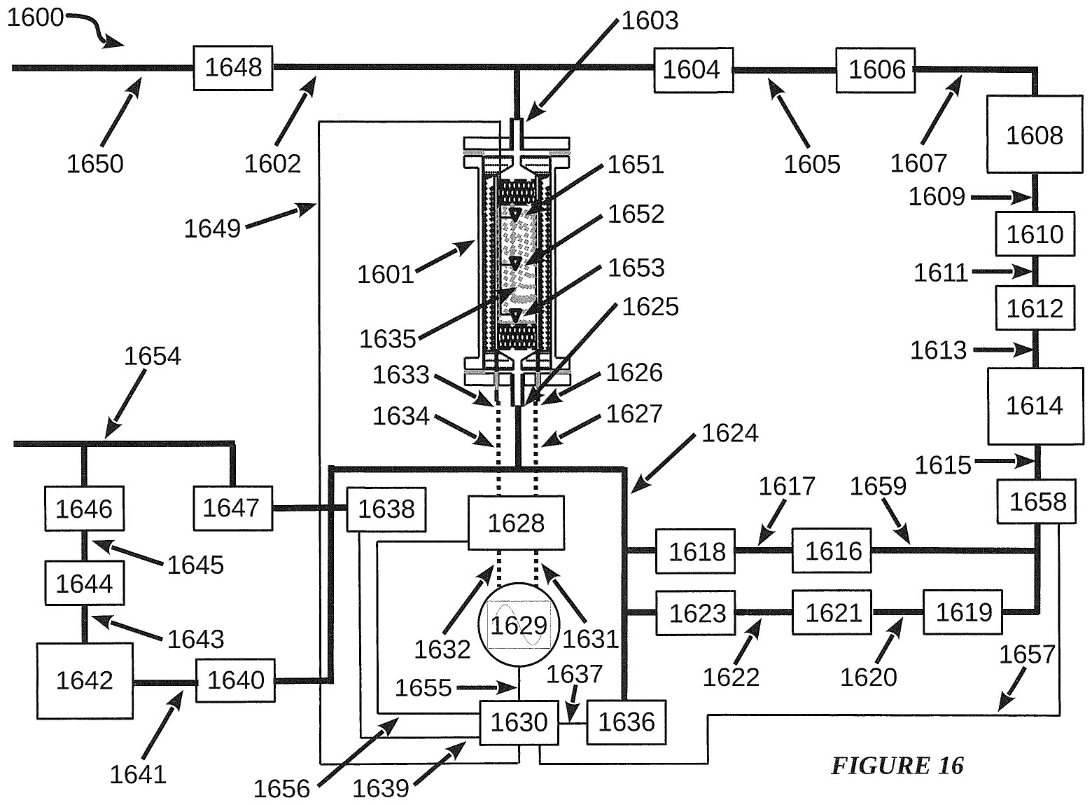

FIG. 16 shows an embodiment of a system 1600 for removing specific polar molecules from an adsorbent material utilizing a gas that may comprise or consist of the desired specific polar molecules for adsorber vessel assembly pressurization, combined with near complete capture of the residual system process gas. This embodiment includes an adsorber vessel assembly 1601 and, as described with respect to FIG. 15, the interconnections between the adsorber vessel assembly 1601, the control sub-system 1630, the connection 1655 between the control system 1630 and the radio frequency energy generator 1629, the radio frequency generator 1629 and the wires 1631 and 1632 connecting the radio frequency generator 1629 to the coupling circuit 1628, the coupling circuit 1628 and the wires 1634 and 1627 connecting the coupling circuit 1628 to the terminations of the electrodes 1633 and 1626. In addition, the system 1600 of the adsorber vessel assembly 1601 shows the one (1) or more temperature sensors 1651, 1652, and 1653, connecting to the control sub-system 1630 through the electrical or optical feedback path 1649. This configuration of system 1600 permits the control sub-system 1630 to control the average output level and timing of application of radio frequency energy from the radio frequency generator 1629 through the coupling circuit 1628 and to the two (2) or more electrode terminations 1633 and 1626 for delivery of radio frequency energy into the adsorbent material 1635 located between the two (2) or more electrodes. In a version of the embodiment where the frequency of operation of the radio frequency generator 1629 is variable, control sub-system 1630 can adjust the frequency through connection 1655 to the radio frequency generator 1629. Feedback regarding the temperature of the adsorbent material 1635 is provided by the aforementioned one (1) or more temperature sensors 1651, 1652 and 1653 through the feedback path 1649. Control sub-system 1630 also receives information from the specific molecule sensor 1638 through path 1639 and information regarding the pressure within the adsorber vessel assembly via pressure sensor 1636 through path 1637. Feedback regarding the amount of specific polar molecules released is measured by the specific molecule measurement module (mass flow meter or other suitable device) 1658 and information is provided to control sub-system 1630 through path 1657. In a version of the embodiment in which coupling circuit 1628 provides a variable impedance transfer function, the control sub-system effects adjustment of the variable impedance transfer function through circuit 1656. In addition to the aforementioned elements, this embodiment may include one or more automated valves 1604, 1618, 1623, 1640, 1647, and 1648, which are actuated by the control sub-system 1630; pressure regulator 1606; specific polar molecule storage tank 1608; boost pumps 1610 and 1646; vacuum pumps 1612 and 1644; vacuum tanks 1614 and 1642; check valves 1616 and 1619; back pressure regulator 1621; and interconnecting piping 1605, 1607, 1609, 1611, 1613, 1615, 1617, 1620, 1622, 1643, 1645, and 1659.

During the adsorption phase of the adsorption/desorption process, the control sub-system 1630 sets the initial conditions wherein valves 1604, 1618, 1623, and 1640 are closed; boost pump 1646 and boost pump 1610 are not operating; valves 1647 and 1648 are open; vacuum pump 1644 is operating (assuring vacuum vessel 1642 is at a deep vacuum); and vacuum pump 1612 is operating (assuring vacuum vessel 1614 is at a deep vacuum). As a result, the combination of the process gas and the specific molecule gas flows from a reactor or other source (not shown) through pipe 1650 through valve 1648 and subsequently through manifold 1602 into adsorber vessel assembly 1601 via inlet 1603. The combination of the process gas and the specific molecule gas continues through adsorbent material 1635, which selectively adsorbs the specific molecules. The remaining process gas flows out of adsorber vessel assembly 1601 via outlet 1625 into manifold 1624, past specific molecule detector 1638, through valve 1647 and pipe 1654, and then returns to the aforementioned reactor or source via one or more compressors and associated pipes and/or valves (not shown), as may be desired. When the specific molecule detector 1638 detects the presence of specific molecules in the gas flow, control sub-system 1630 closes valves 1647 and 1648 to stop the flow of the combination of the process gas and the specific molecule gas from the reactor.

At this point, the adsorbent material 1635 within the adsorber vessel assembly 1601 has adsorbed all the specific molecules it can hold and the interstitial space and voids within adsorber vessel 1601 and manifolds 1602 and 1624 contain residual process gas. It is desirable, or in some embodiments, necessary, that this residual gas be removed prior to the desorption phase of the adsorption/desorption process. The completeness of the residual gas removal (i.e., ppm of residual gas versus gas containing the specific molecules) impacts the purity of the resultant gas, or requires additional processing to remove trace amounts of process gas (the lower the ppm of residual gas the greater the purity of the resultant gas). Furthermore, it is desirable, but not required, to capture the residual process gas and return it to the reactor process gas flow to minimize system losses.

To facilitate this, the control sub-system 1630 opens valve 1640 and turns on boost pump 1646. As the volume of vacuum vessel 1642 is significantly larger than the volume of residual gas, the pressure within the adsorber vessel assembly 1601 and manifold 1602 and manifold 1624 drops quickly (limited by the size of valve 1640, the diameter of manifold 1624, the diameter of the outlet 1625, the diameter of pipe 1641 and/or the size of the opening to vacuum vessel 1642) until it reaches the value determined by Boyle's law, as shown in equation 5.

$$P 1 \cdot V 1 = P 2 \cdot V 2 \qquad ( 5 )$$

Where:
P1 is the pressure in vacuum vessel 1642,
V1 is the volume of vacuum vessel 1642 and associated piping,
P2 is the pressure in adsorber vessel assembly 1601, and
V2 is the combined volume of adsorber vessel assembly 1601, manifold 1602 and manifold 1624

In practice, the volume of vacuum vessel 1642 is limited by physical constraints, such as size and weight, and by cost. With the potential high initial pressure of adsorber vessel assembly 1601, this application of Boyle's law, while instrumental to the process, may not be sufficient to drop the pressure of adsorber vessel assembly 1601 to meet the desired net process purity level. The vacuum pump 1644 continues to reduce the pressure within adsorber vessel assembly 1601, manifold 1602, manifold 1624, vacuum vessel 1642, and pipes 1641 and 1643. Boost pump 1646 and vacuum pump 1644 continue to operate and return the process gas in vacuum vessel 1642 to the reactor process gas flow. This continues until pressure transducer 1636 indicates that the pressure drops to, or below, the pressure to achieve the desired purity, at which time the control sub-system 1630 closes valve 1640 and turns off boost pump 1646 and vacuum pump 1644.

Control sub-system 1630 now opens valve 1604 allowing a small amount of gas which may be comprised of, or consist of, the specific polar molecules to flow from vessel 1608 and through pressure regulator 1606 via pipes 1605 and 1607. The pressure within adsorber vessel assembly 1601, manifold 1602, and manifold 1624 is raised to a value sufficient to satisfy Paschen's Law. While counter-intuitive, the adsorbent material 1635 within adsorber vessel assembly 1601 is already saturated with the specific polar molecules and therefore cannot adsorb any additional polar molecules.

When pressure transducer 1636 signals to control sub-system 1630 that the pressure has satisfied Paschen's Law, control sub-system 1630 closes valve 1604, opens valve 1623, starts a timer within the circuitry of the control sub-system 1630 and turns on radio frequency energy generator 1629, which through wires 1631 and 1632, matching circuit 1628, and wires 1634 and 1627, applies the radio frequency energy to electrodes 1633 and 1626. As the radio frequency energy travels through the adsorbent material 1635, the specific polar molecules are released in gaseous form. This increases the pressure within adsorber vessel assembly 1601, manifold 1602 and manifold 1624. Once the pressure reaches the setting of the back pressure regulator 1621, which is set to a pressure slightly higher than that of pressure regulator 1606, the gas consisting of (or consisting essentially of) the specific polar molecules travels through check valve 1619 and into vacuum vessel 1614 through the mass flow meter (or other suitable device to measure the released specific polar molecules) 1658. Vacuum pump 1612 continues to evacuate vacuum vessel 1614 and delivers the gas to boost pump 1610, which in turn, boosts the pressure and delivers the gas to vessel 1608.

When the control sub-system timer expires or the specific molecule measurement module 1658 measures the desired amount of specific molecules released (as determined by the control sub-system 1630), the control sub-system 1630 closes valve 1623, turns off the radio frequency energy generator 1629, and opens valve 1618. This valve sequence bypasses back pressure regulator 1621 and allows the gas to flow through check valve 1616. As before, Boyle's Law supports the rapid evacuation of adsorber vessel assembly 1601, manifold 1602 and manifold 1624. Vacuum pump 1612 and boost pump 1610 continue to operate until the control sub-system 1630 reads a pressure via pressure transducer 1636 that indicates a sufficient volume of the resultant gas has been captured. Control sub-system 1630 then closes valve 1618 and checks the temperature of the adsorbent material 1635 via the one (1) or more temperature sensors 1651, 1652, and 1653. When the temperature drops to a value that is equal or less than the maximum temperature of adsorption minus the temperature of the exothermic reaction, the residual (interstitial) gas has been re-adsorbed into the adsorbent material 1635 and the control sub-system opens valves 1647 and 1648, returning the adsorber vessel assembly to the adsorption phase.

Radio Frequency Energy Desorption Apparatus and Method 2: Polar Molecule Fill with Partial Process Gas Capture

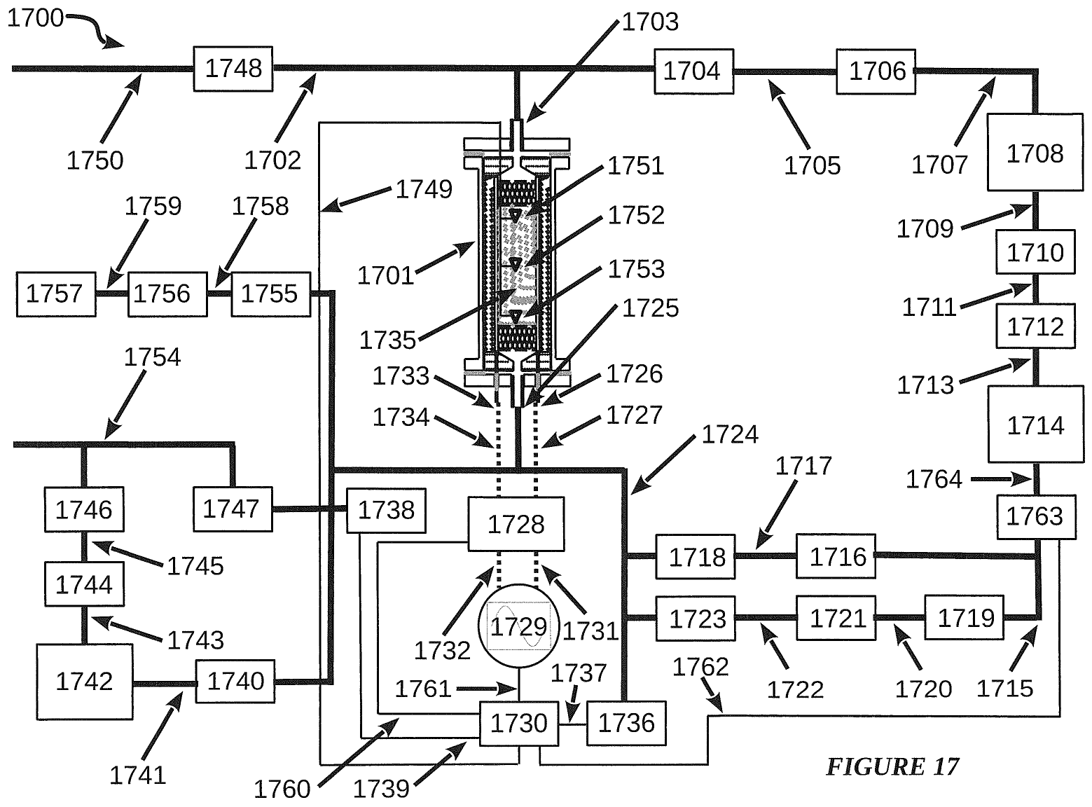

FIG. 17 shows an embodiment of a system 1700 for removing specific polar molecules from an adsorbent material utilizing a gas that may comprise or consist of the desired specific polar molecules for adsorber vessel assembly pressurization, combined with partial capture of the residual system process gas. This embodiment includes an adsorber vessel assembly 1701, and as described with respect to FIG. 15, the interconnections between the adsorber vessel assembly 1701, the control sub-system 1730, the connection 1761 between the control system 1730 and the radio frequency energy generator 1729, the radio frequency generator 1729 and the wires 1731 and 1732 connecting the radio frequency generator 1729 to the coupling circuit 1728, the coupling circuit 1728 and the wires 1734 and 1727 connecting the coupling circuit 1728 to the terminations of the electrodes 1733 and 1726. In addition, the system 1700 of the adsorber vessel assembly 1701 shows the one (1) or more temperature sensors, 1751, 1752, and 1753, connecting to the control sub-system 1730 through the electrical or optical feedback path 1749. This configuration of system 1700 permits the control sub-system 1730 to control the average output level and timing of application of radio frequency energy from the radio frequency generator 1729 through the coupling circuit 1728 and to the two (2) or more electrode terminations 1733 and 1726 for delivery of radio frequency energy into the adsorbent material 1735 located between the two (2) or more electrodes. In a version of the embodiment where the frequency of operation of the radio frequency generator 1729 is variable, control sub-system 1730 can adjust the frequency through connection 1761 to the radio frequency generator 1729. Feedback regarding the temperature of the adsorbent material 1735 is provided by the aforementioned one (1) or more temperature sensors 1751, 1752 and 1753 through the feedback path 1749. Control sub-system 1730 also receives information from the specific molecule sensor 1738 through path 1739 and information regarding the pressure within the adsorber vessel assembly via pressure sensor 1736 through path 1737. Feedback regarding the amount of specific polar molecules released is measured by the specific molecule measurement module (e.g., mass flow meter or other suitable device) 1763 and information is provided to control sub-system 1730 through path 1762. In a version of the embodiment in which coupling circuit 1728 provides a variable impedance transfer function, the control sub-system effects adjustment of the variable impedance transfer function through circuit 1760. In addition to the aforementioned elements, this embodiment may include one or more automated valves 1704, 1718, 1723, 1740, 1747, 1748 and 1755, which are actuated by the control sub-system 1730; pressure regulator 1706; specific polar molecule storage tank 1708; boost pumps 1710 and 1746; vacuum pumps 1712 and 1744; vacuum tanks 1714 and 1742; check valves 1716 and 1719 and 1756; back pressure regulator 1721; and vent/flare 1757; and interconnecting piping 1705, 1707, 1709, 1711, 1713, 1715, 1717, 1720, 1722, 1743, 1745, and 1764.

During the adsorption phase of the adsorption/desorption process, the control sub-system 1730 sets the initial conditions wherein valves 1704, 1718, 1723, 1740 and 1755 are closed; valves 1748 and 1747 are open; boost pump 1746 and boost pump 1710 are not operating; vacuum pump 1744 is operating (assuring vacuum vessel 1742 is at a deep vacuum); and vacuum pump 1712 is operating (assuring vacuum vessel 1714 is at a deep vacuum). As a result, the combination of the process gas and the specific molecule gas flows from a reactor or source (not shown) through pipe 1750 through valve 1748 and subsequently through manifold 1702 into adsorber vessel assembly 1701 via inlet 1703. The combination of the process gas and the specific molecule gas continues through adsorbent material 1735, which selectively adsorbs the specific molecules. The remaining process gas flows out of adsorber vessel assembly 1701 via outlet 1725 into manifold 1724, past specific molecule detector 1738, through valve 1747 and pipe 1754, and then returns to the aforementioned reactor or source via one or more compressors and associated pipes and/or valves (not shown), as may be desired. When the specific molecule detector 1738 detects the presence of specific molecules in the gas flow, control sub-system 1730 closes valves 1747 and 1748 to stop the flow of the combination of the process gas and the specific molecule gas from the reactor.

At this point, the adsorbent material 1735 within the adsorber vessel assembly 1701 has adsorbed all the specific molecules it can hold and the interstitial space and voids within adsorber vessel 1701 and manifolds 1702 and 1724 contain residual process gas. It is desirable, or in some embodiments, necessary, that this residual gas be removed prior to the desorption phase of the adsorption/desorption process. The completeness of the residual gas removal (i.e., ppm of residual gas versus gas containing the specific molecules) impacts the purity of the resultant gas, or requires additional processing to remove trace amounts of process gas (the lower the ppm of residual gas the greater the purity of the resultant gas). Furthermore, it is desirable, but not required, to capture the residual process gas and return it to the reactor process gas flow to minimize system losses.

To reduce the time to facilitate removing the residual gas, the control sub-system 1730 energizes vent/flare 1757 and opens valve 1755. As the volume of the atmosphere is effectively infinitely larger than the volume of residual gas, the pressure within the adsorber vessel assembly 1701 and manifold 1702 and manifold 1724 drops quickly (limited by the diameter of manifold 1724; the diameter of the outlet 1725; the diameter of pipes 1758 and 1759; the size of valve 1755; the size of check valve 1756; the size of vent/flare 1757; and local atmospheric pressure) until the pressure within the adsorber vessel assembly 1701 and manifold 1702 and manifold 1724 reaches atmospheric pressure.

In certain locations, it may be suitable to simply vent the residual gas, based on local laws and regulations. In other locations, it may be required to flare the residual gas, again based on local laws and regulations. Therefore, vent/flare 1757 represents a vent for locations in which venting is acceptable and a flare for locations in which flaring is required.

With the pressure within the adsorber vessel assembly 1701 and manifold 1702 and manifold 1724 now at atmospheric pressure, the control sub-system closes valve 1755 and opens valve 1740 and turns on boost pump 1746 to continue to evacuate the adsorber vessel assembly 1701, manifold 1702 and manifold 1724. As the volume of vacuum vessel 1742 is significantly larger than the remaining volume of residual gas, the pressure within the adsorber vessel assembly 1701 and manifold 1702 and manifold 1724 drops quickly (limited by the size of valve 1740, the diameter of manifold 1724, the diameter of the outlet 1725, the diameter of pipe 1741 and/or the size of the opening to vacuum vessel 1742) until it reaches the value determined by Boyle's law, shown in equation 6.

$$P 1 \cdot V 1 = P 2 \cdot V 2 \qquad ( 6 )$$

Where:
P1 is the pressure in vacuum vessel 1742,
V1 is the volume of vacuum vessel 1742 and associated piping,
P2 is the pressure in adsorber vessel assembly 1701 (starting at atmospheric pressure in this case), and
V2 is the combined volume of adsorber vessel assembly 1701, manifold 1702 and manifold 1724

In practice, the volume of vacuum vessel 1742 is limited by physical constraints, such as size and weight, and by cost. Given the atmospheric pressure of adsorber vessel assembly 1701, this application of Boyle's law, while instrumental to the process, may not be sufficient to drop the pressure of adsorber vessel assembly 1701 to meet the desired net process purity level, although the pressure drops quicker than that of FIG. 16 (assuming equivalent volumes of vacuum vessel 1742 and vacuum vessel 1642). The vacuum pump 1744 continues to reduce the pressure within adsorber vessel assembly 1701, manifold 1702 and manifold 1724. Boost pump 1746 and vacuum pump 1744 continue to operate and return the process gas in vacuum vessel 1742 to the reactor process gas flow. This continues until pressure transducer 1736 indicates that the pressure drops to, or below, the pressure to achieve the desired purity, at which time the control sub-system 1730 closes valve 1740 and turns off boost pump 1746 and vacuum pump 1744.

Control sub-system 1730 now opens valve 1704 allowing a small amount of gas which may be comprised of, or consist of, the specific polar molecules to flow from vessel 1708 and through pressure regulator 1706. The pressure within adsorber vessel assembly 1701, manifold 1702 and manifold 1724 is raised to a value sufficient to satisfy Paschen's Law. While counter-intuitive, the adsorbent material 1735 within adsorber vessel assembly 1701 is already saturated with the specific polar molecules and therefore cannot adsorb any additional polar molecules.

When pressure transducer 1736 signals to control sub-system 1730 that the pressure has satisfied Paschen's Law, control sub-system 1730 closes valve 1704, opens valve 1723, starts a timer within the circuitry of the control sub-system 1730 and turns on radio frequency energy generator 1729, which through wires 1731 and 1732, matching circuit 1728, and wires 1734 and 1727, applies the radio frequency energy to electrodes 1733 and 1726. As the radio frequency energy travels through the adsorbent material 1735, the specific polar molecules are released in gaseous form. This increases the pressure within adsorber vessel assembly 1701, manifold 1702 and manifold 1724. Once the pressure reaches the setting of the back pressure regular 1721, which is set to a pressure slightly higher than that of pressure regulator 1706, the gas consisting of (or consisting essentially of) the specific polar molecules travels through check valve 1719 and into vacuum vessel 1714. Vacuum pump 1712 continues to evacuate vacuum vessel 1714 and delivers the gas to boost pump 1710, which in turn, boosts the pressure and delivers the gas to vessel 1708.

When the control sub-system timer expires or the specific molecule measurement module 1763 measures the desired amount of specific molecules released (as determined by the control sub-system 1730), the control sub-system 1730 closes valve 1723, turns off the radio frequency energy generator 1729, and opens valve 1718. This valve sequence bypasses back pressure regulator 1721 and allows the gas to flow through check valve 1716. As before, Boyle's Law supports the rapid evacuation of adsorber vessel assembly 1701, manifold 1702 and manifold 1724. Vacuum pump 1712 and boost pump 1710 continue to operate until the control sub-system 1730 reads a pressure via pressure transducer 1736 that indicates a sufficient volume of the resultant gas has been captured. Control sub-system 1730 then closes valve 1718 and checks the temperature of the adsorbent material 1735 via the one (1) or more temperature sensors 1751, 1752, and 1753. When the temperature drops to a value that is equal or less than the maximum temperature of adsorption minus the temperature of the exothermic reaction, the residual gas has been re-adsorbed into the adsorbent material 1735 and the control sub-system opens valves 1748 and 1747, returning the adsorber vessel assembly to the adsorption phase.

Radio Frequency Energy Desorption Apparatus and Method 3: Deep Vacuum with Process Gas Capture

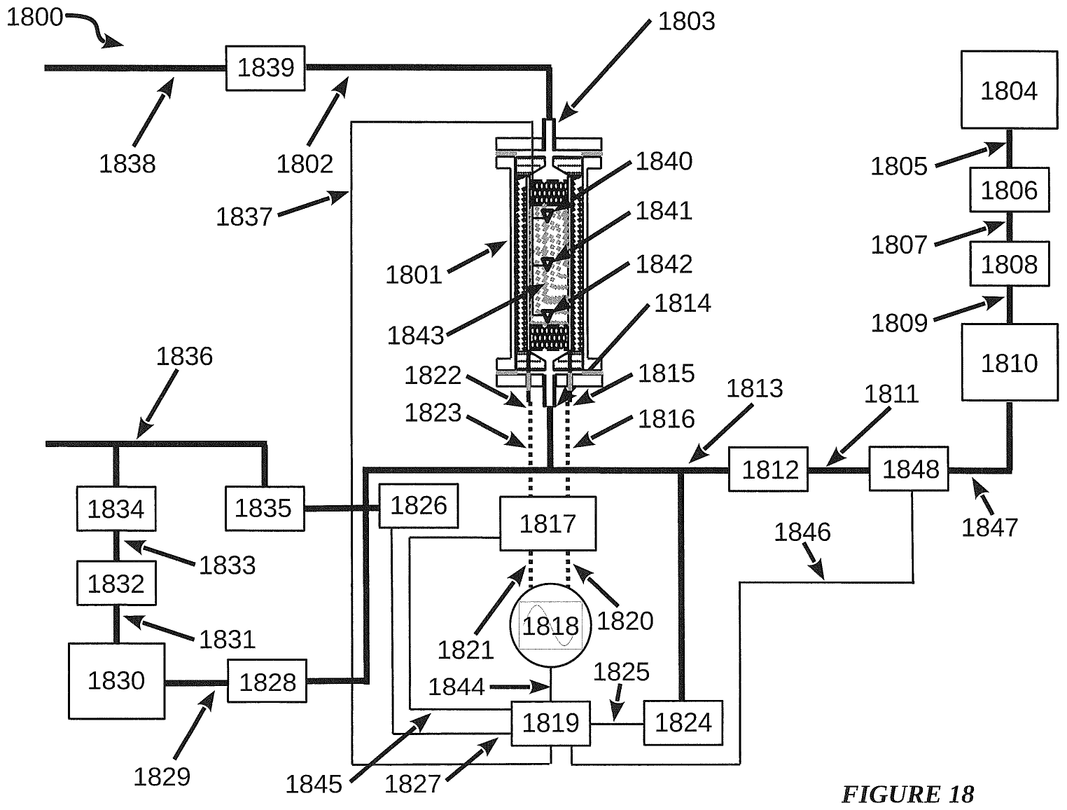

FIG. 18 shows an embodiment of a system 1800 for removing specific polar molecules from an adsorbent material utilizing a deep vacuum, combined with near complete capture of the residual system process gas. This embodiment includes an adsorber vessel assembly 1801, and as described with respect to FIG. 15, the interconnections between the adsorber vessel assembly 1801, the control sub-system 1819, the connection 1844 between the control system 1819 and the radio frequency energy generator 1818, the radio frequency generator 1818 and the wires 1820 and 1821 connecting the radio frequency generator 1818 to the coupling circuit 1817, the coupling circuit 1817 and the wires 1816 and 1823 connecting the coupling circuit 1817 to the terminations of the electrodes 1815 and 1822. In addition, the system 1800 of the adsorber vessel assembly 1801 shows the one (1) or more temperature sensors, 1840, 1841, and 1842, connecting to the control sub-system 1819 through the electrical or optical feedback path 1837. This configuration of system 1800 permits the control sub-system 1819 to control the average output level and timing of application of radio frequency energy from the radio frequency generator 1818 through the coupling circuit 1817 and to the two (2) or more electrode terminations 1815 and 1822 for delivery of radio frequency energy into the adsorbent material 1843 located between the two (2) or more electrodes. In a version of the embodiment where the frequency of operation of the radio frequency generator 1818 is variable, control sub-system 1819 can adjust the frequency through connection 1844 to the radio frequency generator 1818. Feedback regarding the temperature of the adsorbent material 1843 is provided by the aforementioned one (1) or more temperature sensors 1840, 1841, and 1842 through the feedback path 1837. Control sub-system 1819 also receives information from the specific molecule sensor 1826 through path 1827 and information regarding the pressure within the adsorber vessel assembly via pressure sensor 1824 through path 1825. Feedback regarding the amount of specific polar molecules released is measured by the specific molecule measurement module (e.g., mass flow meter or other suitable device) 1848 and information is provided to control sub-system 1819 through path 1846. In a version of the embodiment in which coupling circuit 1817 provides a variable impedance transfer function, the control sub-system effects adjustment of the variable impedance transfer function through circuit 1845. In addition to the aforementioned elements, this embodiment may include on or more automated valves 1812, 1828, 1835 and 1839, which are actuated by the control sub-system 1819; specific polar molecule storage tank 1804; boost pumps 1806 and 1834; vacuum pumps 1808 and 1832; and vacuum tanks 1810 and 1830; and interconnecting piping 1805, 1807, 1809, 1811, 1831, 1833, and 1847.

During the adsorption phase of the adsorption/desorption process, the control sub-system 1819 sets the initial conditions wherein valves 1812 and 1828 are closed; valves 1835 and 1839 are open; boost pump 1834 and boost pump 1806 are not operating; vacuum pump 1832 is operating (assuring vacuum vessel 1830 is at a deep vacuum); and vacuum pump 1808 is operating (assuring vacuum vessel 1810 is at a deep vacuum). As a result, the combination of the process gas and the specific molecule gas flows from a reactor or other source (not shown) through pipe 1838 through valve 1839 and subsequently through manifold 1802 into adsorber vessel assembly 1801 via inlet 1803. The combination of the process gas and the specific molecule gas continues through adsorbent material 1843, which selectively adsorbs the specific molecules. The remaining process gas flows out of adsorber vessel assembly 1801 via outlet 1814 into manifold 1813, past specific molecule detector 1826, through valve 1835 and pipe 1836, and then returns to the aforementioned reactor or source via one or more pumps and associated pipes and/or valves (not shown), as may be desired. When the specific molecule detector 1826 detects the presence of specific molecules in the gas flow, control sub-system 1819 closes valves 1839 and 1835 to stop the flow of the combination of the process gas and the specific molecule gas from the reactor.

At this point, the adsorbent material 1843 within the adsorber vessel assembly 1801 has adsorbed all the specific molecules it can hold and the interstitial space and voids within adsorber vessel 1801 and manifolds 1802 and 1813 contain residual process gas. It is desirable, or in some embodiments, necessary, that this residual gas be removed prior to the desorption phase of the adsorption/desorption process. The completeness of the residual gas removal (i.e., ppm of residual gas versus gas containing the specific molecules) impacts the purity of the resultant gas, or requires additional processing to remove trace amounts of process gas (the lower the ppm of residual gas the greater the purity of the resultant gas). Furthermore, it is desirable, but not required, to capture the residual process gas and return it to the reactor process gas flow to minimize system losses.

To facilitate this, the control sub-system 1819 opens valve 1828, turns on boost pump 1834. As the volume of vacuum vessel 1830 is significantly larger than the volume of residual gas, the pressure within the adsorber vessel assembly 1801 and manifold 1802 and manifold 1813 drops quickly (limited by the size of valve 1828, the diameter of manifold 1813, the diameter of the outlet 1814, the diameter of pipe 1829 and/or the size of the opening to vacuum vessel 1830) until it reaches the value determined by Boyle's law, as shown in equation 7.

$$P 1 \cdot V 1 = P 2 \cdot V 2 \qquad ( 7 )$$

Where:
P1 is the pressure in vacuum vessel 1830,
V1 is the volume of vacuum vessel 1830 and associated piping,
P2 is the pressure in adsorber vessel assembly 1801, and
V2 is the combined volume of adsorber vessel assembly 1801, manifold 1802 and manifold 1813

In practice, the volume of vacuum vessel 1830 is limited by physical constraints, such as size and weight, and by cost. With the potential high initial pressure of adsorber vessel assembly 1801, this application of Boyle's law, while instrumental to the process, may not be sufficient to drop the pressure of adsorber vessel assembly 1801 to meet the desired net process purity level. The vacuum pump 1832 continues to reduce the pressure within adsorber vessel assembly 1801, manifold 1802 and manifold 1813. Boost pump 1834 and vacuum pump 1832 continue to operate and return the process gas in vacuum vessel 1830 to the reactor process gas flow. This continues until pressure transducer 1824 indicates that the pressure drops to, or below, the pressure to achieve the desired purity, at which time the control sub-system 1819 closes valve 1828 and turns off boost pump 1834.

When pressure transducer 1824 signals to control sub-system 1819 that the pressure has satisfied Paschen's Law, control sub-system 1819 opens valve 1812, turns on boost pump 1806 starts a timer within the circuitry of the control sub-system 1819 and turns on radio frequency energy generator 1818, which through wires 1821 and 1820, matching circuit 1817, and wires 1823 and 1816, applies the radio frequency energy to electrodes 1822 and 1815. As the radio frequency energy travels through the adsorbent material 1843, the specific polar molecules are released in gaseous form. The gas consisting of (or consisting essentially of) the specific polar molecules travels through valve 1812 and into vacuum vessel 1810. Vacuum pump 1808 continues to evacuate vacuum vessel 1810 and delivers the gas to boost pump 1806, which in turn, boosts the pressure and delivers the gas to vessel 1804.

When the control sub-system timer expires or the specific molecule measurement module 1848 measures the desired amount of specific molecules released (as determined by the control sub-system 1819), the control sub-system 1819 closes valve 1812 and turns off the radio frequency energy generator 1818. Control sub-system 1819 then checks the temperature of the adsorbent material 1843 via the one (1) or more temperature sensors 1840, 1841, and 1842. When the temperature drops to a value that is equal or less than the maximum temperature of adsorption minus the temperature of the exothermic reaction, the control sub-system 1819 opens valve 1839 and valve 1835, returning the adsorber vessel assembly to the adsorption phase.

Radio Frequency Energy Desorption Apparatus and Method 4: Deep Vacuum with Partial Process Gas Capture

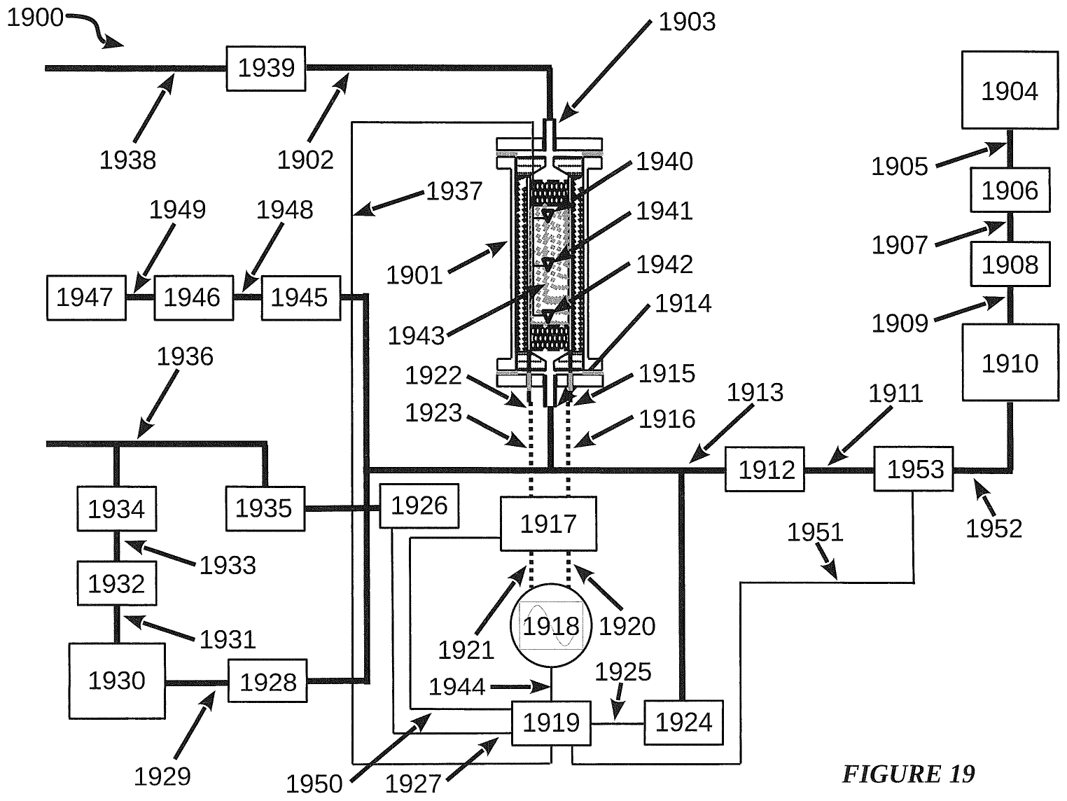

FIG. 19 shows an embodiment of a system 1900 for removing specific polar molecules from an adsorbent material utilizing a sweep gas, combined with near complete capture of the residual system process gas. This embodiment includes an adsorber vessel assembly 1901, and as described with respect to FIG. 15, the interconnections between the adsorber vessel assembly 1901, the control sub-system 1919, the connection 1944 between the control system 1919 and the radio frequency energy generator 1918, the coupling circuit 1917 and the wires 1921 and 1920 connecting the radio frequency generator 1918 to the coupling circuit 1917, the coupling circuit 1917 and the wires 1916 and 1923 connecting the coupling circuit 1917 to the terminations of the electrodes 1915 and 1922. In addition, the system 1900 of the adsorber vessel assembly 1901 shows the one (1) or more temperature sensors, 1940, 1941, and 1942, connecting to the control sub-system 1919 through the electrical or optical feedback path 1937. This configuration of system 1900 permits the control sub-system 1919 to control the average output level and timing of application of radio frequency energy from the radio frequency generator 1918 through the coupling circuit 1917 and to the two (2) or more electrode terminations 1922 and 1915 for delivery of radio frequency energy into the adsorbent material 1943 located between the two (2) or more electrodes. In a version of the embodiment where the frequency of operation of the radio frequency generator 1918 is variable, control sub-system 1919 can adjust the frequency through connection 1944 to the radio frequency generator 1918. Feedback regarding the temperature of the adsorbent material 1943 is provided by the aforementioned one (1) or more temperature sensors 1940, 1941, and 1942 through the feedback path 1937. Control sub-system 1919 also receives information from the specific molecule sensor 1926 through path 1927 and information regarding the pressure within the adsorber vessel assembly via pressure sensor 1924 through path 1925. Feedback regarding the amount of specific polar molecules released is measured by the specific molecule measurement module (e.g., mass flow meter or other suitable device) 1953 and information is provided to control sub-system 1919 through path 1951. In a version of the embodiment in which coupling circuit 1917 provides a variable impedance transfer function, the control sub-system effects adjustment of the variable impedance transfer function through circuit 1950. In addition to the aforementioned elements, this embodiment may include one or more automated valves 1912, 1928, 1935, 1939 and 1945, which are actuated by the control sub-system 1919; specific polar molecule storage tank 1904; boost pumps 1906 and 1934; vacuum pumps 1908 and 1932; vacuum tanks 1910 and 1930; check valve 1946; vent/flare 1947; and interconnecting piping 1905, 1907, 1909, 1911, 1929, 1931, 1933, and 1952.

During the adsorption phase of the adsorption/desorption process, the control sub-system 1919 sets the initial conditions wherein valves 1912, 1928 and 1945 are closed; valves 1935 and 1939 are open; boost pump 1934 and boost pump 1906 are not operating; vacuum pump 1932 is operating (assuring vacuum vessel 1930 is at a deep vacuum); and vacuum pump is operating (assuring vacuum vessel 1910 is at a deep vacuum). As a result, the combination of the process gas and the specific molecule gas flows from a reactor or other source (not shown) through pipe 1938 through valve 1939 and subsequently through manifold 1902 into adsorber vessel assembly 1901 via inlet 1903. The combination of the process gas and the specific molecule gas continues through adsorbent material 1943, which selectively adsorbs the specific molecules. The remaining process gas flows out of adsorber vessel assembly 1901 via outlet 1914 into manifold 1913, past specific molecule detector 1926, through valve 1935 and pipe 1936, and then returns to the aforementioned reactor or source via one or more pumps and associated pipes and/or valves (not shown), as may be desired. When the specific molecule detector 1926 detects the presence of specific molecules in the gas flow, control sub-system 1919 closes valves 1935 and 1939 to stop the flow of the combination of the process gas and the specific molecule gas from the reactor.

At this point, the adsorbent material 1943 within the adsorber vessel assembly 1901 has adsorbed all the specific molecules it can hold and the interstitial space and voids within adsorber vessel 1901 and manifolds 1902 and 1913 contain residual process gas. It is desirable, or in some embodiments, necessary, that this residual gas be removed prior to the desorption phase of the adsorption/desorption process. The completeness of the residual gas removal (i.e., ppm of residual gas versus gas containing the specific molecules) impacts the purity of the resultant gas, or requires additional processing to remove trace amounts of process gas (the lower the ppm of residual gas the greater the purity of the resultant gas). Furthermore, it is desirable, but not required, to capture the residual process gas and return it to the reactor process gas flow to minimize system losses.

To reduce the time to facilitate removing the residual gas, the control sub-system 1919 opens valve 1945 and energizes vent/flare 1947. As the volume of the atmosphere is effectively infinitely larger than the volume of residual gas, the pressure within the adsorber vessel assembly 1901 and manifold 1902 and manifold 1913 drops quickly (limited by the diameter of manifold 1913; the diameter of the outlet 1914; the diameter of pipes 1948 and 1949; the size of valve 1945; the size of check valve 1946; the size of vent/flare 1947; and local atmospheric pressure) until the pressure within the adsorber vessel assembly 1901 and manifold 1902 and manifold 1913 reaches atmospheric pressure.

In certain locations, it may be suitable to simply vent the residual gas, based on local laws and regulations. In other locations, it may be required to flare the residual gas, again based on local laws and regulations. Therefore, vent/flare 1947 represents a vent for locations in which venting is acceptable and a flare for locations in which flaring is required.

With the pressure within the adsorber vessel assembly 1901 and manifold 1902 and manifold 1913 now at atmospheric pressure, the control sub-system closes valve 1945, opens valve 1928, and turns on boost pump 1934 to continue to evacuate the adsorber vessel assembly 1901, manifold 1902 and manifold 1913. As the volume of vacuum vessel 1930 is significantly larger than the volume of residual gas, the pressure within the adsorber vessel assembly 1901 and manifold 1902 and manifold 1913 drops quickly (limited by the size of valve 1928, the diameter of manifold 1913, the diameter of the outlet 1914, the diameter of pipe 1929 and/or the size of the opening to vacuum vessel 1930) until it reaches the value determined by Boyle's law, as shown in equation 8.

$$P 1 \cdot V 1 = P 2 \cdot V 2 \qquad ( 8 )$$

Where:
P1 is the pressure in vacuum vessel 1930,
V1 is the volume of vacuum vessel 1930 and associated piping,
P2 is the pressure in adsorber vessel assembly 1901, and
V2 is the combined volume of adsorber vessel assembly 1901, manifold 1902 and manifold 1913

In practice, the volume of vacuum vessel 1930 is limited by physical constraints, such as size and weight, and by cost. Given the atmospheric pressure of adsorber vessel assembly 1901 at this point, the application of Boyle's law, while instrumental to the process, may not be sufficient to drop the pressure of adsorber vessel assembly 1901 to meet the desired net process purity level, although the pressure drops quicker and to a lower value than that of FIG. 18 (assuming equivalent volumes of vacuum vessel 1901 and 1801). The vacuum pump 1932 continues to reduce the pressure within adsorber vessel assembly 1901, manifold 1902 and manifold 1913. Boost pump 1934 and vacuum pump 1932 continue to operate and return the process gas in vacuum vessel 1930 to the reactor process gas flow. This continues until pressure transducer 1924 indicates that the pressure drops to, or below, the pressure to achieve the desired purity, at which time the control sub-system 1919 closes valve 1928, and turns off boost pump 1934.

When pressure transducer 1924 signals to control sub-system 1919 that the pressure has satisfied Paschen's Law, control sub-system 1919 opens valve 1912, starts a timer within the circuitry of the control sub-system 1919 and turns on radio frequency energy generator 1918, which through wires 1920 and 1921, matching circuit 1917, and wires 1916 and 1923, applies the radio frequency energy to electrodes 1915 and 1922. As the radio frequency energy travels through the adsorbent material 1943, the specific polar molecules are released in gaseous form. The gas consisting of (or consisting essentially of) the specific polar molecules travels through valve 1912 and into vacuum vessel 1910. Vacuum pump 1908 continues to evacuate vacuum vessel 1910 and delivers the gas to boost pump 1906, which in turn, boosts the pressure and delivers the gas to vessel 1904.

When the control sub-system timer expires or the specific molecule measurement module 1953 measures the desired amount of specific molecules released (as determined by the control sub-system 1919), the control sub-system 1919 closes valve 1912 and turns off the radio frequency energy generator 1918. Control sub-system 1919 then checks the temperature of the adsorbent material 1943 via the one (1) or more temperature sensors 1940, 1941, and 1942. When the temperature drops to a value that is equal or less than the maximum temperature of adsorption minus the temperature of the exothermic reaction, the control sub-system 1919 opens valves 1935 and 1939, returning the adsorber vessel assembly to the adsorption phase.

Radio Frequency Energy Desorption Apparatus and Method 5: Sweep Gas with Process Gas Capture

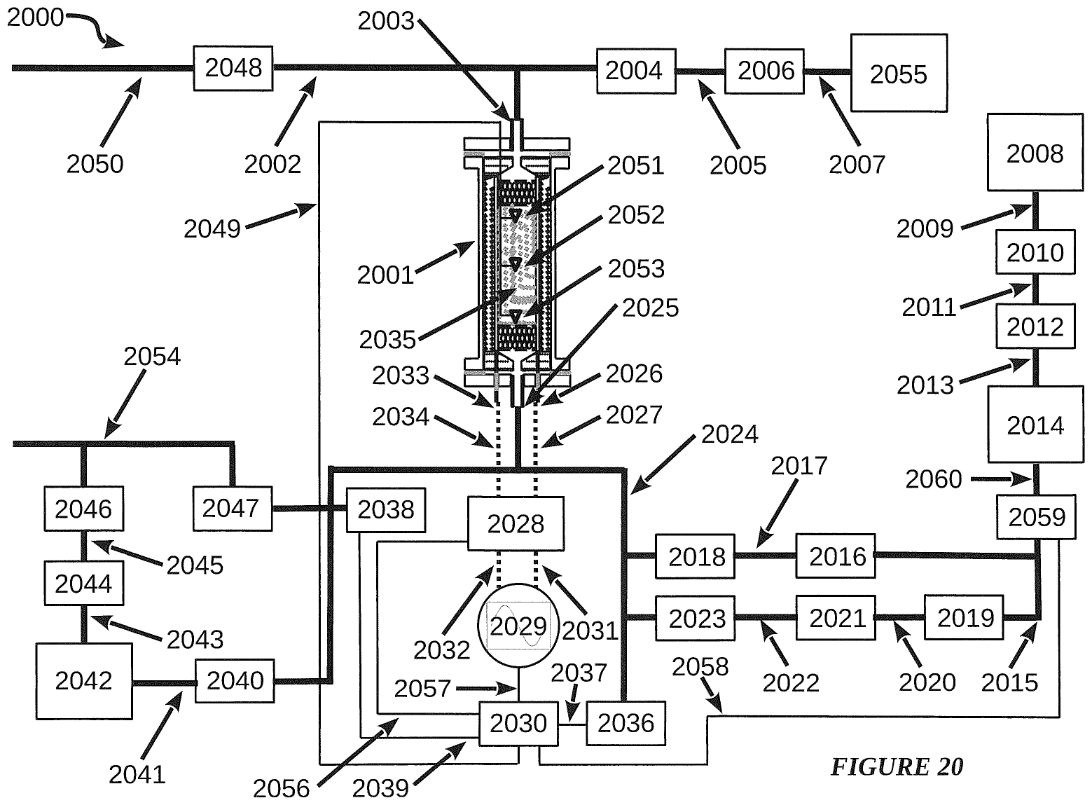

FIG. 20 shows an embodiment of a system 2000 for removing specific polar molecules from an adsorbent material utilizing a sweep gas, combined with partial capture of the residual system process gas. This embodiment includes an adsorber vessel assembly 2001, and as described with respect to FIG. 15, the interconnections between the adsorber vessel assembly 2001, the control sub-system 2030, the connection 2057 between the control system 2030 and the radio frequency energy generator 2029, the radio frequency generator 2029 and the wires 2031 and 2032 connecting the radio frequency generator 2029 to the coupling circuit 2028, the coupling circuit 2028 and the wires 2027 and 2034 connecting the coupling circuit 2028 to the terminations of the electrodes 2026 and 2033. In addition, the system 2000 of the adsorber vessel assembly 2001 shows the one (1) or more temperature sensors, 2051, 2052, and 2053, connecting to the control sub-system 2030 through the electrical or optical feedback path 2049. This configuration of system 2000 permits the control sub-system 2030 to control the average output level and timing of application of radio frequency energy from the radio frequency generator 2029 through the coupling circuit 2028 and to the two (2) or more electrode terminations 2033 and 2026 for delivery of radio frequency energy into the adsorbent material 2035 located between the two (2) or more electrodes. In a version of the embodiment where the frequency of operation of the radio frequency generator 2029 is variable, control sub-system 2030 can adjust the frequency through connection 2057 to the radio frequency generator 2029. Feedback regarding the temperature of the adsorbent material 2035 is provided by the aforementioned one (1) or more temperature sensors 2051, 2052 and 2053 through the feedback path 2049. Control sub-system 2030 also receives information from the specific molecule sensor 2038 through path 2039 and information regarding the pressure within the adsorber vessel assembly via pressure sensor 2036 through path 2037. Feedback regarding the amount of specific polar molecules released is measured by the specific molecule measurement module (e.g., mass flow meter or other suitable device) 2059 and information is provided to control sub-system 2030 through path 2058. In a version of the embodiment in which coupling circuit 2028 provides a variable impedance transfer function, the control sub-system 2030 effects adjustment of the variable impedance transfer function through circuit 2056. In addition to the aforementioned elements, this embodiment may include one or more automated valves 2004, 2018, 2023, 2040, 2047, and 2048, which are actuated by the control sub-system 2030; pressure regulator 2006; sweep gas storage tank 2055; specific molecule storage tank 2008; boost pumps 2010 and 2046; vacuum pumps 2012 and 2044; vacuum tanks 2014 and 2042; check valves 2016 and 2019; back pressure regulator 2021; and interconnecting piping 2005, 2007, 2009, 2011, 2013, 2015, 2017, 2020, 2022, 2043, and 2045.

During the adsorption phase of the adsorption/desorption process, the control sub-system 2030 sets the initial conditions wherein valves 2004, 2018, 2023, and 2040 are closed; valves 2047 and 2048 are open; boost pump 2046 and boost pump 2010 are not operating; vacuum pump 2044 is operating (assuring vacuum vessel 2042 is at a deep vacuum); and vacuum pump 2012 is operating (assuring vacuum vessel 2014 is at a deep vacuum). As a result, the combination of the process gas and the specific molecule gas flows from a reactor or other source (not shown) through pipe 2050 through valve 2048 and subsequently through manifold 2002 into adsorber vessel assembly 2001 via inlet 2003. The combination of the process gas and the specific molecule gas continues through adsorbent material 2035, which selectively adsorbs the specific molecules. The remaining process gas flows out of adsorber vessel assembly 2001 via outlet 2025 into manifold 2024, past specific molecule detector 2038, through valve 2047 and pipe 2054, and then returns to the aforementioned reactor or source via one or more pumps and associated pipes and/or valves (not shown), as may be desired. When the specific molecule detector 2038 detects the presence of specific molecules in the gas flow, control sub-system 2030 closes valves 2047 and 2048 to stop the flow of the combination of the process gas and the specific molecule gas from the reactor.

At this point, the adsorbent material 2035 within the adsorber vessel assembly 2001 has adsorbed all the specific molecules it can hold and the interstitial space and voids within adsorber vessel 2001 and manifolds 2002 and 2024 contain residual process gas. It is desirable, or in some embodiments, necessary, that this residual gas be removed prior to the desorption phase of the adsorption/desorption process. The completeness of the residual gas removal (i.e., ppm of residual gas versus gas containing the specific molecules) impacts the purity of the resultant gas, or requires additional processing to remove trace amounts of process gas (the lower the ppm of residual gas the greater the purity of the resultant gas). Furthermore, it is desirable, but not required, to capture the residual process gas and return it to the reactor process gas flow to minimize system losses.

To facilitate this, the control sub-system 2030 opens valve 2040 and turns on boost pump 2046. As the volume of vacuum vessel 2042 is significantly larger than the volume of residual gas, the pressure within the adsorber vessel assembly 2001 and manifold 2002 and manifold 2024 drops quickly (limited by the size of valve 2040, the diameter of manifold 2024, the diameter of the outlet 2025, the diameter of pipe 2041 and/or the size of the opening to vacuum vessel 2042) until it reaches the value determined by Boyle's law, as shown in equation 9.

$$P 1 \cdot V 1 = P 2 \cdot V 2 \qquad ( 9 )$$

Where:
P1 is the pressure in vacuum vessel 2042,
V1 is the volume of vacuum vessel 2042 and associated piping,
P2 is the pressure in adsorber vessel assembly 2001, and
V2 is the combined volume of adsorber vessel assembly 2001, manifold 2002 and manifold 2024

In practice, the volume of vacuum vessel 2042 is limited by physical constraints, such as size and weight, and by cost. With the potential high initial pressure of adsorber vessel assembly 2001, this application of Boyle's law, while instrumental to the process, may not be sufficient to drop the pressure of adsorber vessel assembly 2001 to meet the desired net process purity level. The vacuum pump 2044 continues to reduce the pressure within adsorber vessel assembly 2001, manifold 2002 and manifold 2024. Boost pump 2046 and vacuum pump 2044 continue to operate and return the process gas in vacuum vessel 2042 to the reactor process gas flow. This continues until pressure transducer 2036 indicates that the pressure drops to, or below, the pressure to achieve the desired purity, at which time the control sub-system 2030 closes valve 2040 and turns off boost pump 2046.

Control sub-system 2030 now opens valve 2004 allowing a small amount of sweep gas which may be comprised of, or consist of, molecules that either are not adsorbed, or only minimally adsorbed (i.e., temporally adsorbed but will be released as the pressure in adsorber vessel 2001 is lowered) by the adsorbent material 2035 to flow from vessel 2055 and through pressure regulator 2006. The pressure within adsorber vessel assembly 2001, manifold 2002 and manifold 2024 is raised to a value sufficient to satisfy Paschen's Law.

When pressure transducer 2036 signals to control sub-system 2030 that the pressure has satisfied Paschen's Law, control sub-system 2030 closes valve 2004, opens valve 2023, starts a timer within the circuitry of the control sub-system 2030 and turns on radio frequency energy generator 2029, which through wires 2031 and 2032, matching circuit 2028, and wires 2034 and 2027, applies the radio frequency energy to electrodes 2033 and 2026. As the radio frequency energy travels through the adsorbent material 2035, the specific polar molecules are released in gaseous form. This increases the pressure within adsorber vessel assembly 2001, manifold 2002 and manifold 2024. Once the pressure reaches the setting of the back pressure regular 2021, which is set to a pressure slightly higher than that of pressure regulator 2006, the gas comprising the specific polar molecules and the sweep gas travels through check valve 2019 and into vacuum vessel 2014. Vacuum pump 2012 continues to evacuate vacuum vessel 2014 and delivers the gas to boost pump 2010, which in turn, boosts the pressure and delivers the gas to vessel 2008.

When the control sub-system timer expires or the specific molecule measurement module 2059 measures the desired amount of specific molecules released (as determined by the control sub-system 2030), the control sub-system 2030 closes valve 2023, turns off the radio frequency energy generator 2029, and opens valve 2018. This valve sequence bypasses back pressure regulator 2021 and allows the gas to flow through check valve 2016. As before, Boyle's Law supports the rapid evacuation of adsorber vessel assembly 2001, manifold 2002 and manifold 2024. Vacuum pump 2012 and boost pump 2010 continue to operate until the control sub-system 2030 reads a pressure via pressure transducer 2036 that indicates a sufficient volume of the resultant gas has been captured. Control sub-system 2030 then closes valve 2018 and checks the temperature of the adsorbent material 2035 via the one (1) or more temperature sensors 2051, 2052, and 2053. When the temperature drops to a value that is equal or less than the maximum temperature of adsorption minus the temperature of the exothermic reaction, the residual gas has been re-adsorbed into the adsorbent material 2035 and the control sub-system opens valves 2047 and 2048, returning the adsorber vessel assembly to the adsorption phase.

Note that there are three (3) specific preferences for the sweep gas: i) it needs to have a condensation point at a temperature and pressure higher than a gas comprising the specific polar molecules so that it can be separated during a post-process step (outside the scope of this embodiment), such a post-process step could be, but is not limited to: liquefaction of the gas comprising the specific polar molecules (this technique is known in the art), ii) it must be selected such that it will not remain adsorbed in the adsorbent material 2035 following the desorption process, iii) it is either compatible with the process gas or, ideally, one (1) of the gasses within the process gas mixture. In the case of the specific molecule being NH₃, N₂ (nitrogen) is an acceptable choice.

It should also be noted that this embodiment uses the sweep gas to raise the pressure within the adsorber vessel 2001 and then stops flowing. Alternatively, the sweep gas could be permitted to flow continuously, but this would consume more sweep gas and require more energy to remove it from the specific polar molecules during a post-process step.

Radio Frequency Energy Desorption Apparatus and Method 6: Sweep Gas with Partial Process Gas Capture

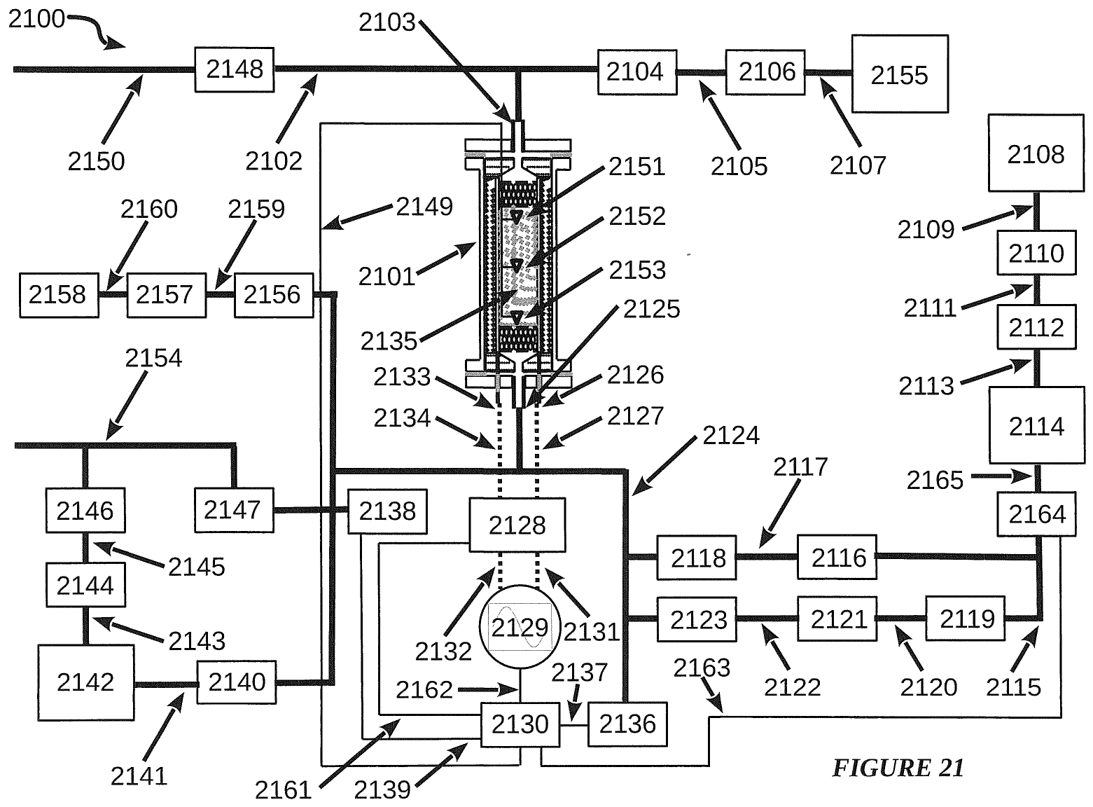

FIG. 21 shows an embodiment of a system 2100 for removing specific polar molecules from an adsorbent material utilizing a gas that may comprise or consist of the desired specific polar molecules for adsorber vessel assembly pressurization, combined with partial capture of the residual system process gas. This embodiment includes an adsorber vessel assembly 2101, and as described with respect to FIG. 15, the interconnections between the adsorber vessel assembly 2101, the control sub-system 2130, the connection 2162 between the control system 2130 and the radio frequency energy generator 2129, the radio frequency generator 2129 and the wires 2131 and 2132 connecting the radio frequency generator 2129 to the coupling circuit 2128, the coupling circuit 2128 and the wires 2127 and 2134 connecting the coupling circuit 2128 to the terminations of the electrodes 2126 and 2133. In addition, the system 2100 of the adsorber vessel assembly 2101 shows the one (1) or more temperature sensors, 2151, 2152, and 2153, connecting to the control sub-system 2130 through the electrical or optical feedback path 2149. This configuration of system 2100 permits the control sub-system 2130 to control the average output level and timing of application of radio frequency energy from the radio frequency generator 2129 through the coupling circuit 2128 and to the two (2) or more electrode terminations 2133 and 2126 for delivery of radio frequency energy into the adsorbent material 2135 located between the two (2) or more electrodes. In a version of the embodiment where the frequency of operation of the radio frequency generator 2129 is variable, control sub-system 2130 can adjust the frequency through connection 2162 to the radio frequency generator 2129. Feedback regarding the temperature of the adsorbent material 2135 is provided by the aforementioned one (1) or more temperature sensors 2151, 2152 and 2153 through the feedback path 2149. Control sub-system 2130 also receives information from the specific molecule sensor 2138 through path 2139 and information regarding the pressure within the adsorber vessel assembly via pressure sensor 2136 through path 2137. Feedback regarding the amount of specific polar molecules released is measured by the specific molecule measurement module (e.g., mass flow meter or other suitable device) 2164 and information is provided to control sub-system 2130 through path 2163. In a version of the embodiment in which coupling circuit 2128 provides a variable impedance transfer function, the control sub-system 2130 effects adjustment of the variable impedance transfer function through circuit 2161. In addition to the aforementioned elements, this embodiment may include one or more automated valves 2104, 2118, 2123, 2140, 2147, 2148 and 2156, which are actuated by the control sub-system 2130; pressure regulator 2106; sweep gas storage tank 2155; specific polar molecule storage tank 2108; boost pumps 2110 and 2146; vacuum pumps 2112 and 2144; vacuum tanks 2114 and 2142; check valves 2116, 2119 and 2157; back pressure regulator 2121; vent/flare 2158; and interconnection piping 2105, 2107, 2109, 2111, 2113, 2115, 2117, 2120, 2122, 2143, and 2145.

During the adsorption phase of the adsorption/desorption process, the control sub-system 2130 sets the initial conditions wherein valves 2104, 2118, 2123, 2140 and 2156 are closed; valves 2147 and 2148 are open; boost pump 2146 and boost pump 2110 are not operating; vacuum pump 2144 is operating (assuring vacuum vessel 2142 is at a deep vacuum); and vacuum pump 2112 is operating (assuring vacuum vessel 2114 is at a deep vacuum). As a result, the combination of the process gas and the specific molecule gas flows from a reactor or other source (not shown) through pipe 2150 through valve 2148 and subsequently through manifold 2102 into adsorber vessel assembly 2101 via inlet 2103. The combination of the process gas and the specific molecule gas continues through adsorbent material 2135, which selectively adsorbs the specific molecules. The remaining process gas flows out of adsorber vessel assembly 2101 via outlet 2125 into manifold 2124, past specific molecule detector 2138, through valve 2147 and pipe 2154, and then returns to the aforementioned reactor or source via one or more pumps and associated pipes and/or valves (not shown), as may be desired. When the specific molecule detector 2138 detects the presence of specific molecules in the gas flow, control sub-system 2130 closes valves 2147 and 2148 to stop the flow of the combination of the process gas and the specific molecule gas from the reactor.

At this point, the adsorbent material 2135 within the adsorber vessel assembly 2101 has adsorbed all the specific molecules it can hold and the interstitial space and voids within adsorber vessel 2101 and manifolds 2102 and 2124 contain residual process gas. It is desirable, and in some embodiments, necessary, that this residual gas be removed prior to the desorption phase of the adsorption/desorption process. The completeness of the residual gas removal (i.e., ppm of residual gas versus gas containing the specific molecules) impacts the purity of the resultant gas, or requires additional processing to remove trace amounts of process gas (the lower the ppm of residual gas the greater the purity of the resultant gas). Furthermore, it is desirable, but not required, to capture the residual process gas and return it to the reactor process gas flow to minimize system losses.

To reduce the time to facilitate removing the residual gas, the control sub-system 2130 energizes vent/flare 2158 and opens valve 2156. As the volume of the atmosphere is effectively infinitely larger than the volume of residual gas, the pressure within the adsorber vessel assembly 2101 and manifold 2102 and manifold 2124 drops quickly (limited by the diameter of manifold 2124; the diameter of the outlet 2125; the diameter of pipes 2159 and 2160; the size of valve 2156; the size of check valve 2157; the size of vent/flare 2158; and local atmospheric pressure) until the pressure within the adsorber vessel assembly 2101 and manifold 2102 and manifold 2124 reaches atmospheric pressure.

In certain locations, it may be suitable to simply vent the residual gas, based on local laws and regulations. In other locations, it may be required to flare the residual gas, again based on local laws and regulations. Therefore, vent/flare 2158 represents a vent for locations in which venting is acceptable and a flare for locations in which flaring is required.

With the pressure within the adsorber vessel assembly 2101 and manifold 2102 and manifold 2124 now at atmospheric pressure, the control sub-system closes valve 2156, opens valve 2140, and turns on boost pump 2146 to continue to evacuate the adsorber vessel assembly 2101, manifold 2102 and manifold 2124. As the volume of vacuum vessel 2142 is significantly larger than the remaining volume of residual gas, the pressure within the adsorber vessel assembly 2101 and manifold 2102 and manifold 2124 drops quickly (limited by the size of valve 2140, the diameter of manifold 2124, the diameter of the outlet 2125, the diameter of pipe 2141 and/or the size of the opening to vacuum vessel 2142) until it reaches the value determined by Boyle's law, shown in equation 10.

$$P 1 \cdot V 1 = P 2 \cdot V 2 \qquad ( 10 )$$

Where:
P1 is the pressure in vacuum vessel 2142,
V1 is the volume of vacuum vessel 2142 and associated piping,
P2 is the pressure in adsorber vessel assembly 2101 (starting at atmospheric pressure in this case), and
V2 is the combined volume of adsorber vessel assembly 2101, manifold 2102 and manifold 2124

In practice, the volume of vacuum vessel 2142 is limited by physical constraints, such as size and weight, and by cost. Given the atmospheric pressure of adsorber vessel assembly 2101, this application of Boyle's law, while instrumental to the process, may not be sufficient to drop the pressure of adsorber vessel assembly 2101 to meet the desired net process purity level, although the pressure drops quicker than that of FIG. 20 (assuming equivalent volumes of vacuum vessel 2142 and vacuum vessel 2042). The vacuum pump 2144 continues to reduce the pressure within adsorber vessel assembly 2101, manifold 2102 and manifold 2124. Boost pump 2146 and vacuum pump 2144 continue to operate and return the process gas in vacuum vessel 2142 to the reactor process gas flow. This continues until pressure transducer 2136 indicates that the pressure drops to, or below, the pressure to achieve the desired purity, at which time the control sub-system 2130 closes valve 2140, and turns off boost pump 2146.

Control sub-system 2130 now opens valve 2104 allowing a small amount of sweep gas which may be comprised of, or consist of, molecules that either are not adsorbed, or only minimally adsorbed (i.e., temporally adsorbed but will be released as the pressure in adsorber vessel 2101 is lowered) by the adsorbent material 2135 to flow from vessel 2155 and through pressure regulator 2106. The pressure within adsorber vessel assembly 2101, manifold 2102 and manifold 2124 is raised to a value sufficient to satisfy Paschen's Law.

When pressure transducer 2136 signals to control sub-system 2130 that the pressure has satisfied Paschen's Law, control sub-system 2130 closes valve 2104, opens valve 2123, starts a timer within the circuitry of the control sub-system 2130 and turns on radio frequency energy generator 2129, which through wires 2131 and 2132, matching circuit 2128, and wires 2127 and 2134, applies the radio frequency energy to electrodes 2126 and 2133. As the radio frequency energy travels through the adsorbent material 2135, the specific polar molecules are released in gaseous form. This increases the pressure within adsorber vessel assembly 2101, manifold 2102 and manifold 2124. Once the pressure reaches the setting of the back pressure regulator 2121, which is set to a pressure slightly higher than that of pressure regulator 2106, the gas comprising the specific polar molecules and the sweep gas travels through check valve 2119 and into vacuum vessel 2114. Vacuum pump 2112 continues to evacuate vacuum vessel 2114 and delivers the gas to boost pump 2110, which in turn, boosts the pressure and delivers the gas to vessel 2108.

When the control sub-system timer expires or the specific molecule measurement module 2164 measures the desired amount of specific molecules released (as determined by the control sub-system 2130), the control sub-system 2130 closes valve 2123, turns off the radio frequency energy generator 2129, and opens valve 2118. This valve sequence bypasses back pressure regulator 2121 and allows the gas to flow through check valve 2116. As before, Boyle's Law supports the rapid evacuation of adsorber vessel assembly 2101, manifold 2102 and manifold 2124. Vacuum pump 2112 and boost pump 2110 continue to operate until the control sub-system 2130 reads a pressure via pressure transducer 2136 that indicates a sufficient volume of the resultant gas has been captured. Control sub-system 2130 then closes valve 2118 and checks the temperature of the adsorbent material 2135 via the one (1) or more temperature sensors 2151, 2152, and 2153. When the temperature drops to a value that is equal or less than the maximum temperature of adsorption minus the temperature of the exothermic reaction, the residual gas has been re-adsorbed into the adsorbent material 2135 and the control sub-system opens valves 2147 and 2148, returning the adsorber vessel assembly to the adsorption phase.

As with the previous apparatus and method, there are three (3) specific preferences for the sweep gas: i) it needs to have a condensation point at a temperature and pressure higher than a gas comprising the specific polar molecules so that it can be separated during a post-process step (outside the scope of this embodiment), such a post-process step could be, but is not limited to: liquefaction of the gas comprising the specific polar molecules (this technique is known in the art), ii) it must be selected such that it will not remain adsorbed in the adsorbent material 2135 following the desorption process, iii) it is either compatible with the process gas or, ideally, one (1) of the gasses within the process gas mixture. In the case of the specific molecule being NH₃, N₂ (nitrogen) is an acceptable choice.

As with some embodiments of the previously described apparatus and methods, this embodiment uses the sweep gas to raise the pressure within the adsorber vessel 2101 and then stops flowing. Alternatively, the sweep gas could be permitted to flow continuously, but this would consume more sweep gas and require more energy to remove it from the specific polar molecules during a post-process step.

FIGS. 16, 17, 18, 19, 20 and 21 show various embodiments of the systems described herein but do not show how the resultant polar molecules are removed from the disclosed systems. However, it should be appreciated that, in industry practice, the vacuum pump and boost pump used to deliver the gas containing the specific polar molecules from the adsorber vessel assembly would likely feed a condenser/chiller to condense the specific molecules, yielding a liquid that would then be pumped into a liquid storage tank. Take off, or removal of specific polar molecules from the storage tank would typically be in liquid form. Any contaminates contained in the gas from the adsorber vessel assembly would be removed from the head space of the condenser in another process (potentially including a vent and/or flare). The head space in the liquid storage tank could be the source of specific molecule gas under pressure that would be used in, for example, the embodiments shown in FIGS. 16 and 17. The technique of liquefaction as described in this paragraph is known in the art and is therefore not shown in FIGS. 16, 17, 18, 19, 20 and 21. That being said, other removal and storage systems and methods can be used with the technology described herein.

While the embodiments described herein refer in many instances to NH₃ as the specific polar molecule, it should be appreciated that the systems and methods described herein can be used with any specific polar molecule, taking into consideration i) the conditions required to maintain the specific polar molecule in a gaseous form, ii) operation within pressure and pd limits as required by Paschen's Law, iii) use of an adsorbent material that will adsorb the specific polar molecule and not adsorb any related process gasses, and iv) use of an adsorbent material that is not reactive to radio frequency energy. Other exemplary specific polar molecules that may be used with the systems and methods described herein include, but are not limited to: N₂S (dinitrogen sulfide), SO₂ (sulfur dioxide), C₂H₅OH (ethanol), CH₃OH (methanol), C₃H₈O (isopropyl alcohol), (CH₃)₂CO (acetone), H₂S (hydrogen sulfide), CO (carbon monoxide), O₃ (ozone), and H₂O (water).

The following enhancements apply, as appropriate, to each of the previously described embodiments (e.g., embodiments 1 through 6).

Each embodiment described herein may, as appropriate, be enhanced by the implementation of the adsorbent material in bead form. While the beads do not have to be spherical, there may be improved packing of the adsorbent material wherein the beads are in spherical form with each spherical bead having the same radius (as much as can be practically realized). There may be yet again further improved packing of the adsorbent material where the adsorbent material is in spherical bead form comprising two (2) or more size groups of spherical beads having different radii such that the smaller beads can fill interstitial space created by larger beads. Irrespective of the shape of the adsorbent, the adsorbent material may be further enhanced when it is comprised of a molecular sieve, which may yet again be further enhanced when the molecular sieve comprises natural and/or synthetic zeolite. Further enhancement may be facilitated wherein the adsorbent material comprises one or more of 4 Å, 5 Å, or 13X zeolites.

The adsorbent material may be further enhanced by comprising a material or structure that supports a process gas mixture through the adsorbent material, the process gas mixture comprising H₂, N₂ and NH₃, wherein the adsorbent material selectively adsorbs NH₃ while allowing a mixture of H₂ and N₂ to pass through the adsorbent material.

Each embodiment described herein may, as appropriate, be facilitated by providing the radio frequency energy wherein the radio frequency generator has at least one (1) output frequency that is within the range of 3 kilohertz to 300 gigahertz. There are advantages in using an output frequency (or output frequencies) selected from the list of ISM frequencies shown in FIG. 1. The ISM frequencies include: a) 6.78 megahertz with a bandwidth not to exceed 30 kilohertz, b) 13.56 megahertz with a bandwidth not to exceed 14 kilohertz, c) 27.12 megahertz with a bandwidth not to exceed 326 kilohertz, d) 40.68 megahertz with a bandwidth not to exceed 40 kilohertz, e) 433.92 megahertz with a bandwidth not to exceed 1.74 megahertz, f) 915 megahertz with a bandwidth not to exceed 26 megahertz, g) 2.45 gigahertz with a bandwidth not to exceed 100 megahertz, h) 24.125 gigahertz with a bandwidth not to exceed 250 megahertz, i) 61.25 gigahertz with a bandwidth not to exceed 500 megahertz, j) 122.5 gigahertz with a bandwidth not to exceed 1 gigahertz, and k) g) 245 gigahertz with a bandwidth not to exceed 2 gigahertz.

Each embodiment described herein may, as appropriate, be further improved by providing the radio frequency energy at a variable power level. There are at least two (2) methods for facilitating this: a) having a radio frequency generator that is configured to linearly adjust the output power ranging from zero to 100%, and b) having a radio frequency generator that is configured to supply variable length bursts of radio frequency energy cycles to achieve an average output power ranging from zero to 100%. In the operating mode of (b), there may be advantages in which the variable length bursts of radio frequency energy cycles are emitted in integer multiples of cycles, however this is not required.

In some embodiments, the radio frequency energy is directed to electrodes within the adsorber vessel. These electrodes may comprise parallel metallic plates themselves comprised of a material that facilitates conduction of electromagnetic waves through the adsorbent material. In some embodiments, the metallic plates can comprise, or can be plated with, a material that does not degrade in the presence of the polar molecules, nor degrade in the presence of any process gasses. In some embodiments, the metallic plates can comprise, or can be plated with, aluminum, carbon steel, copper, gold, nickel, platinum, silver, stainless steel, or some other non degrading metal.

In some embodiments, the adsorber vessel is capable of an operating pressure at or below the maximum system pressure and is also capable of an operating pressure at or above the minimum system pressure, as the adsorber vessel will be subjected to both maximum system pressure and minimum system pressure and at pressures anywhere between the maximum and minimum system pressures.

Each embodiment described herein, as appropriate, may be enhanced with the inclusion of one (1) or more temperature sensors placed within the adsorbent material. To facilitate this, the one (1) or more temperature sensors are preferably, and in some embodiments, necessarily, impervious to, and non-reactive with, radio frequency energy, and are preferably, and in some embodiments, necessarily, non-impactive to radio frequency energy. While not limiting the construction of the one (1) or more temperature sensors, an acceptable construction of the temperature sensors is to utilize one (1) or more fiber optic temperature probes.

In some embodiments, the technology described herein may be enhanced by having the specific polar molecules in gaseous form, and may be further enhanced by having the specific polar molecules comprise anhydrous ammonia NH₃.

In some embodiments which utilize non-adsorptive gas, such a gas, or combination of gasses, is not adsorbed by the adsorbent, or if adsorbed by the adsorbent while the gas is at an elevated pressure, does not block or diminish the magnitude of adsorption of the specific polar molecules. Suitable gasses include, but are not limited to noble gasses, such as argon (Ar), helium (He), krypton (Kr), neon (Ne), oganesson (Og), radon (Rn), or xenon (Xe), or any combination thereof. Another suitable non-adsorptive gas comprises Nitrogen (N₂). A further enhancement of the utilization of non-adsorptive gas is a gas that has a unique condensation temperature and pressure point higher than that of the specific polar molecule.

In some embodiments, a control circuit configured to actuate external valves and receive signals from external sensors to assure the timing of the actuation of the external valves functions in coordination with all other control circuits is provided.

It should be noted that various embodiments as described herein utilize at least one (1) back pressure regulator. As would be appreciated by those of ordinary skill in the art, a back pressure regulator can be implemented as a single device, or as a combination of two (2) or more devices, such as an automated valve, a pressure transducer, and a control circuit that actuated the automated valve in conjunction with information received from the pressure transducer.

It should be noted that the specific sequence of valves and devices can be modified as would be well understood by those of ordinary skill in the art to achieve the same or similar results as those described herein, and such variations are considered to be part of the technology described herein.

Finally, although not discussed in detail herein, those of ordinary skill in the art would readily appreciate that configurations of electrodes can be implemented such that more than two (2) electrodes are used in the various embodiments described herein. For example, one (1) driven electrode (i.e., from the radio frequency generator) can be placed between two (2) ground electrodes, thus creating two (2) areas in which adsorbent material with specific polar molecules adsorbed therein can be subjected to radio frequency energy. This “sandwich” approach can be extended to endless combinations of electrodes.

From the foregoing, it will be appreciated that specific embodiments of the invention have been described herein for purposes of illustration, but that various modifications may be made without deviating from the scope of the invention. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Unless otherwise indicated, all number or expressions, such as those expressing dimensions, physical characteristics, etc., used in the specification (other than the claims) are understood as modified in all instances by the term “approximately”. At the very least, and not as an attempt to limit the application of the doctrine of equivalents to the claims, each numerical parameter recited in the specification or claims which is modified by the term “approximately” should at least be construed in light of the number of recited significant digits and by applying rounding techniques. Moreover, all ranges disclosed herein are to be understood to encompass and provide support for claims that recite any and all sub-ranges or any and all individual values subsumed therein. For example, a stated range of 1 to 10 should be considered to include and provide support for claims that recite any and all sub-ranges or individual values that are between and/or inclusive of the minimum value of 1 and the maximum value of 10; that is, all sub-ranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

1. An apparatus for removing a specific quantity of specific polar molecules from an adsorbent material, comprising:
an adsorber vessel having at least one inlet and one outlet, the at least one inlet being configured to introduce one or more gasses into the adsorber vessel and the at least one outlet being configured to remove the one or more gasses from the adsorber vessel, wherein at least one of the one or more gasses contains the specific polar molecules;
an adsorbent material disposed within the adsorber vessel, the adsorbent material having the specific polar molecules adsorbed therein;
two or more electrodes disposed within the adsorber vessel and being configured to direct energy into the adsorbent material, wherein the adsorbent material is positioned between the two or more electrodes;
a radio frequency generator configured to provide energy to the two or more electrodes; a matching network configured to facilitate flow of energy from the radio frequency generator to the two or more electrodes; and
a first control circuit configured to adjust either the frequency output of the radio frequency generator or the matching network impedance transfer function to maintain the impedance match between the radio frequency generator and the two or more electrodes as the specific polar molecules are removed from the adsorbent material.

2. The apparatus of claim 1, wherein the radio frequency generator is set to a specific frequency and the specific frequency is maintained constant during operation of the apparatus.

3. The apparatus of claim 2, wherein the matching network impedance transfer function is adjustable such that the first control circuit can adjust the matching network impedance transfer function to compensate for the difference between the output impedance of the radio frequency generator and the impedance presented by the two or more electrodes both before and while the specific polar molecules are removed from the adsorbent material.

4. The apparatus of claim 1, wherein the matching network is configured to have a fixed impedance.

5. The apparatus of claim 4, wherein the radio frequency generator's output frequency is variable during operation of the apparatus such that the first control circuit can adjust the radio frequency generator's output frequency to compensate for the difference between the impedance of the output of the radio frequency generator and the impedance presented by the two or more electrodes both before and while the specific polar molecules are removed from the adsorbent material.

6. The apparatus of claim 1, further comprising:
one or more pressure sensors configured to measure the pressure within the adsorber vessel; and
a second control circuit configured to adjust the timing of the application of output power from the radio frequency generator as a function of the pressure within the adsorber vessel.

7. The apparatus of claim 1, further comprising:
one or more measurement sensors configured to measure the total output of the specific polar molecules exiting the adsorber vessel; and
a third control circuit configured to adjust the duration of the application of output power from the radio frequency generator as a function of the total output of the specific polar molecules exiting the adsorber vessel.

8. The apparatus of claim 1, further comprising:
one or more temperature sensors configured to measure the temperature of the adsorbent material contained within the adsorber vessel; and
a fourth control circuit configured to adjust the output power of the radio frequency generator as a function of the temperature of the adsorbent material as measured by the one or more temperature sensors.

9. The apparatus of claim 8, further comprising:
a fifth control circuit configured to actuate external valves and receive signals from external sensors to assure the timing of the actuation of the external valves functions in coordination with the first control circuit, the second control circuit, the third control circuit, the fourth control circuit, or any combination thereof.

10. The apparatus of claim 9, further comprising:
a source of a non-adsorptive gas; and
a pressure regulator configured to deliver the non-adsorptive gas into the adsorber vessel at a specific pressure;
wherein the delivery of the non-adsorptive gas is controlled by operation of the external valves by the fifth control circuit.

11. The apparatus of claim 9, further comprising:
a source of a gas consisting of the specific polar molecules; and
a pressure regulator configured to deliver the gas consisting of the specific polar molecules into the adsorber vessel at a specific pressure;
wherein the delivery of the gas consisting of the specific polar molecules is controlled by operation of the external valves by the fifth control circuit.

12. The apparatus of claim 8, further comprising:
a back pressure regulator in fluid communication with the outlet,
wherein the back pressure regulator is configured to maintain a specific pressure level within the adsorber vessel such that when the specific polar molecules are released from the adsorbent, causing the pressure in the adsorber vessel to exceed the specific pressure level, the gas or gasses exit from the back pressure regulator until the pressure level in the adsorber vessel returns to, or remains at, the specific pressure level.

13. A method for desorbing a specific polar molecule from an adsorbent material located in an adsorber vessel, comprising:
providing an adsorbent material having a specific polar molecule adsorbed therein; and
exposing the adsorbent material to radio frequency energy delivered by two or more electrodes to thereby desorb the specific polar molecule from the adsorbent material.

14. The method of claim 13 wherein process gas, or gasses, is present in the adsorbent material, in the spaces between the adsorbent material, or both, the method further comprising:
evacuating the interstitial process gas from the adsorber vessel to reduce the pressure within the adsorber vessel to a value that assures that arcing between the electrodes is prevented.

15. The method of claim 13, further comprising:
evacuating the interstitial process gas from the adsorber vessel and introducing target polar molecules in gaseous form at a specific pressure into the adsorber vessel to replace the interstitial process gas with the target polar molecules in gaseous form at a specific pressure.

16. The method of claim 13, further comprising:
allowing the pressure to build in the adsorber vessel until it equals or exceeds, a specific release pressure, at which point a stream of over-pressure gas, or gasses, containing target polar molecules is released from the adsorber vessel, until the pressure within the adsorber vessel returns to, or below, the specific release pressure.

17. The method of claim 13, further comprising:
applying radio frequency energy from a radio frequency generator when the pressure within the adsorber vessel has reached a specific pressure.

18. The method of claim 17, further comprising:
terminating the application of the radio frequency energy when a specific quantity of polar molecules has been released from the adsorbent material.

19. The method of claim 17 further comprising:
adjusting the average output power of the radio frequency generator to maintain the temperature of the adsorbent material at a specific temperature.

20. The method of claim 17, further comprising:
limiting the duration of application of the radio frequency energy by a timer that starts at the first application of radio frequency energy and provides a termination signal when the timer reaches the maximum time permitted.

21.-23. (canceled)
